(19) United States
(12) Patent Application Publication
(10) Pub. No.: US 2023/0148140 A1
(43) Pub. Date: May 11, 2023

(54) BASE INTERFACE FOR A TELECOMMUNICATIONS CLOSURE

(71) Applicant: COMMSCOPE CONNECTIVITY BELGIUM BV, Kessel-Lo (BE)

(72) Inventors: Marc DE MESMAEKER, Leuven (BE); Pieter VERMEULEN, Westerlo (BE); Sandra GOOSSENS, Tienen (BE); Marc Eugène Willem BERVOETS, Hasselt (BE); Mohamed AZNAG, Scherpenheuvel Zichem (BE); Olivier C. ROCHE, Bruxelles (BE)

(73) Assignee: COMMSCOPE CONNECTIVITY BELGIUM BV, Kessel-Lo (BE)

(21) Appl. No.: 17/916,386

(22) PCT Filed: Mar. 30, 2021
(86) PCT No.: PCT/IB2021/000223

§ 371 Date: Sep. 30, 2022

Related U.S. Application Data
(60) Provisional application No. 63/002,086, filed on Mar. 30, 2020.
(60) Provisional application No. 63/044,909, filed on Jun. 26, 2020.

(51) Int. Cl. G02B 6/46; G02B 6/36

(52) U.S. Cl. CPC G02B 6/46; G02B 6/3616

(57) ABSTRACT

A telecommunications closure includes a base interface (10) for supporting the closure (60) during assembly, or repair, or later servicing, or installation, or as a permanent mount. The base interface (10) includes structure for mounting to cables, structure for mounting to elements for connecting to the interior elements of the closure (60), and elements for mounting to an interface support. A support device can be used as a workstand, a lift device, a pole mount, a wall mount or another mounting system.

### CROSS-REFERENCE TO RELATED APPLICATIONS

This application is being filed on Mar. 30, 2021 as a PCT International Patent Application and claims the benefit of U.S. patent application Ser. No. 63/002,086, filed on Mar. 30, 2020, and claims the benefit of U.S. patent application Ser. No. 63/044,909, filed on Jun. 26, 2020, the disclosures of which are incorporated herein by reference in their entireties.

### BACKGROUND

Various closures are known in the telecommunications industry for receiving cables and enclosing telecommunications equipment and components within the enclosure, such as cables, splices, splitters, and cable connectors and adaptors. Enclosures may also include cable fixation devices. Fiber optic cables and equipment can be managed and protected by the closures.

Telecommunications equipment, such as the closures, contain telecommunications cables and connectivity equipment, often in a sealed interior. The closures need to be worked on by a technician. Sometimes the work is needed during initial installation. Other times the work is needed after installation to make a repair or to make a change in the cable or connectivity equipment. With the telecommunications equipment there are typically telecommunications connections between cables, such as fiber cables, for connecting the closure to other pieces of equipment, such as a central office, a telecommunications hub, a multi-service terminal, or a customer's premises.

In the case of some closures, cables enter and exit the closure through a seal of a base and a cover or dome covers the internal equipment and mounts to the base in a sealed fashion.

When the closures need to be worked on by a technician, there is a need for devices, systems, and methods for holding the closures in a manner that allows a technician to work on the internal elements of the closure without having to simultaneously hold the closure or otherwise work on it in an unstable arrangement, such as with the closure lying on the ground or on a work table in an unsecured manner.

There is a need to improve one or more aspects of these telecommunications enclosures including such items as ease of assembly, ease of installation, ease of repair or servicing after initial installation, ease of mounting the functioning closure to other structures, and other aspects of the closures.

### SUMMARY

A base interface is provided for a telecommunications closure includes structure for mounting to the closure as a workstand.

The base interface can include structure for mounting cables to the base interface.

The base interface can be used in combination with other features for mounting the closure to a pole or other device in the field.

The base interface can mount to a support device which is mountable to a wall, a pole, a workstand, or a lifting device.

### BRIEF DESCRIPTION OF THE DRAWINGS

FIG. 1 shows an example embodiment of a base interface including cable mounting brackets, wherein the base interface is mounted to two horizontally oriented rod ends.

FIG. 2 shows the two horizontally positioned rods of FIG. 1.

FIG. 3 shows the base interface mounted to two vertically oriented rod ends.

FIG. 4 shows a cable attachment bracket separated from the base interface of the type for mounting to one or more cables.

FIG. 5 shows an example cable mounted to the cable mounting bracket of FIG. 4.

FIG. 6 shows the cable mounted to the bracket and the bracket mounted to the base interface.

FIG. 7 shows interior elements of a closure being initially mounted to the base interface of FIG. 6.

FIG. 8 shows a further step in the mounting process of FIG. 7.

FIG. 9 shows a base of the exterior of the closure during mounting of the base to the closure interior elements.

FIG. 10 shows the base mounted and positioned over the cable ceiling area.

FIG. 11 shows the dome cover of the closure ready for mounting over the interior elements and mounting to the base.

FIG. 12 shows the dome cover mounted to the base.

FIG. 13 shows another example embodiment of a base interface.

FIG. 14 shows a mounting bracket for mounting to the base interface of FIG. 13.

FIG. 15 shows the base interface of FIG. 13 mounted to the mounting bracket of FIG. 14.

FIG. 16 shows a cable mounting bracket.

FIG. 17 shows a cable mounted to the cable bracket of FIG. 16.

FIG. 18 shows the cable mounting bracket with the attached cable mounted to the base interface.

FIG. 19 shows the closure interior elements mounted to the base interface.

FIG. 20 shows a gel segment mounted over the cable relative to the view of FIG. 19.

FIG. 21 shows the closure base added over a lower portion of the interior elements of the closure, including the gel seal.

FIG. 22 shows a dome closure added and connected to the base of the closure.

FIG. 23 shows an alternative embodiment of a base interface.

FIG. 24 shows the alternative embodiment of the base interface of FIG. 23, with a different cable mounting bracket in one of the bracket mounting locations.

FIG. 25 is a top perspective view of another embodiment of a base interface which receives a U-shaped rod, and showing a support device mounted to a U-shaped channel.

FIG. 26 is front elevational view of the view of FIG. 25.

FIG. 27 is a bottom perspective view of the views of FIGS. 25 and 26.

FIG. 28 is a rear elevational view of the view of FIG. 25.

FIG. 29 is further top perspective view of the view of FIG. 25.

FIG. 30 is a further bottom perspective view of the view of FIG. 25.

FIG. 31 is a further view showing the interior elements of the closure removed from the base interface.

FIG. 32 is a front perspective view of the support device of FIG. 25.

FIG. 33 is a rear perspective view of the support device of FIG. 32.

FIG. 34 is a front elevational view of the support device of FIG. 25.

FIG. 35 is a rear elevational view of the support device of FIG. 25.

FIG. 36 is a top perspective view of the base interface of FIG. 25.

FIG. 37 is a bottom perspective view of the base interface of FIG. 25.

FIG. 38 is a top view of the view of FIG. 25.

FIG. 39 is a side view of the view of FIG. 25.

FIG. 40 is a partial cross-section along lines 40-40 of FIG. 39.

FIG. 41 is an exploded view of FIG. 25.

FIG. 42 is a top perspective view of another embodiment of a base interface usable with the U-shaped rod of FIG. 25 and the support device of FIG. 25.

FIG. 43 is a view of FIG. 42 without the interior elements and the base of FIG. 42.

FIG. 44 is a top perspective view of the base interface of FIG. 42.

FIG. 45 is a bottom perspective view of the base interface of FIG. 44.

FIG. 46 is a top view of the base interface of FIG. 44.

FIG. 47 is a bottom view of the base interface of FIG. 44.

FIG. 48 is an exploded view of the view of FIG. 42.

FIG. 49 shows the base interface, the U-shaped rod, and the support device of FIG. 42 mounted to a pole.

FIG. 50 shows the device of FIG. 49, without the interior elements and the base of the closure.

FIG. 51 is an alternative view of the view of FIG. 50.

FIG. 52 shows the base interface, the U-shaped rod, and the support device of FIG. 42 mounted to a wall.

FIG. 53 shows the device of FIG. 52 without the interior elements and the base of the closure.

FIG. 54 is a side view of the view of FIG. 53.

FIG. 55 shows the base interface, the U-shaped rod, and the support device of FIG. 42 mounted to a workstand on a table in a vertical orientation.

FIG. 56 is a close-up view of the view of FIG. 55.

FIG. 57 is an exploded view of the view of FIGS. 55 and 56.

FIG. 58 shows the workstand mounted to a table in a horizontal orientation.

FIG. 59 shows the support device shown in previous figures with an alternative form, and mounted to a U-shaped channel in a similar manner, and including an alternative closure mounting bracket.

FIG. 60 is a top perspective view of another embodiment of a base interface which receives a mounting bracket which is mounted to a U-shaped channel, and the base interface being mounted to some interior elements of a closure.

FIG. 61 is a further top perspective view of the embodiment of FIG. 60 of the base interface and the mounting bracket, and a base of the closure mounted to the mounting bracket.

FIG. 62 is a bottom view of the base interface, the interior elements, the mounting bracket, the base, and the U-shaped channel of FIGS. 60 and 61.

FIG. 63 is an exploded perspective view of the base interface, the interior elements, the mounting bracket, and the base of FIGS. 61 and 62.

FIG. 64 is a top perspective view of the base interface of FIGS. 60-63.

FIG. 65 is a top perspective of the mounting bracket of FIGS. 60-63.

FIG. 66 is a further bottom perspective view of the mounting bracket of FIG. 65.

FIG. 67 is a top perspective view of a closure mounted to a wall with the mounting backet of FIGS. 60-63, 65, and 66.

FIG. 68 is a closeup perspective of a mounting support of the closure of FIG. 67.

FIG. 69 is a perspective view of the mounting support of FIGS. 67 and 68.

FIG. 70 is a closeup of another mounting support usable with the U-shaped channel.

### DETAILED DESCRIPTION

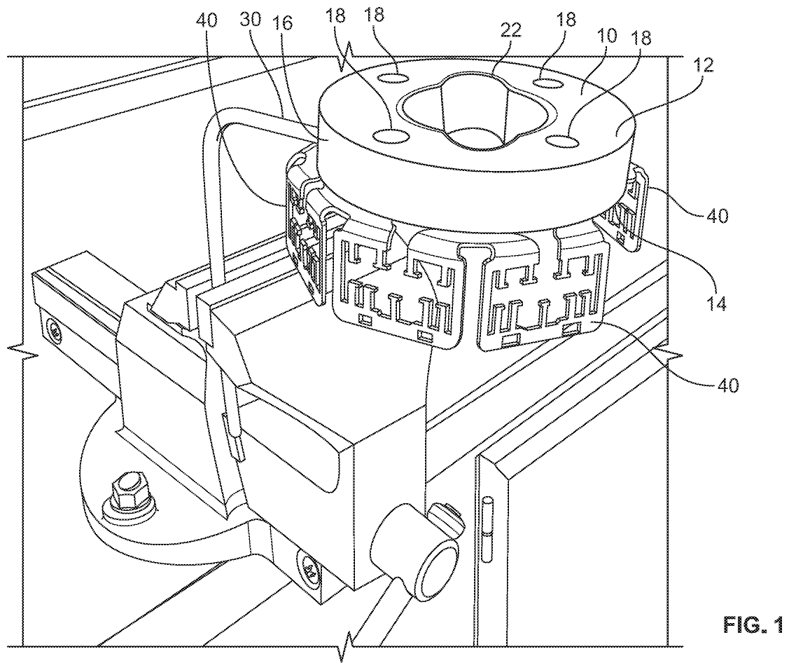

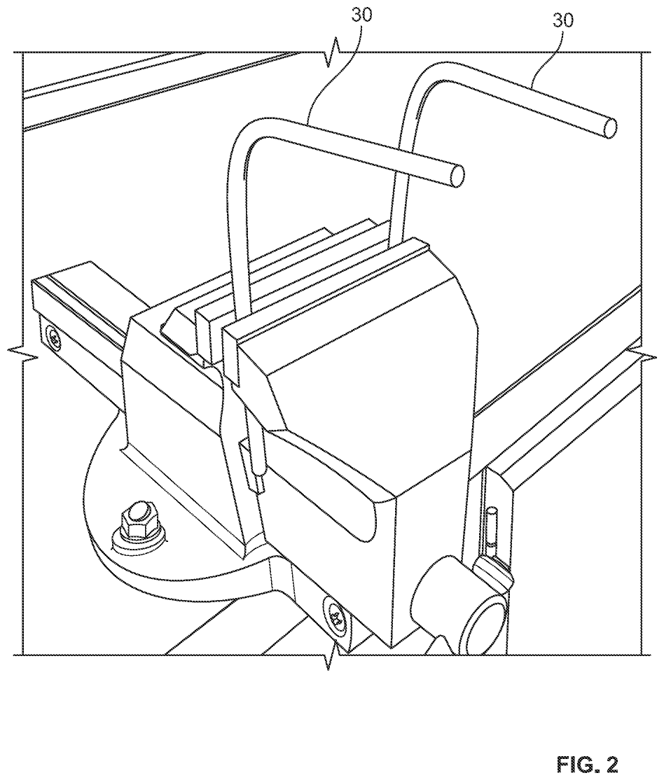

Referring now to FIGS. 1 and 2, a base interface 10 is shown having a disk shape with an upper surface 12, a lower surface 14, and a side surface 16. Mounting openings 18 are for use in mounting the base interface to a closure, such as with posts on the closure and fasteners through the base interface 10.

Side openings 20 are used to mount to one or more support rods 30 or other support structure for use as a workstand to assemble or to repair or service, or for use as a permanent mounting structure for mounting the closure to another structure. Fasteners can be used to mount the base interface 10 to the support rods 30.

Cable mounting brackets 40 are mounted to base interface 10. Cable mounting brackets 40 are separable from base interface 10. Cable mounting brackets 40 can be mounted to the lower surface of base interface 10 in one example.

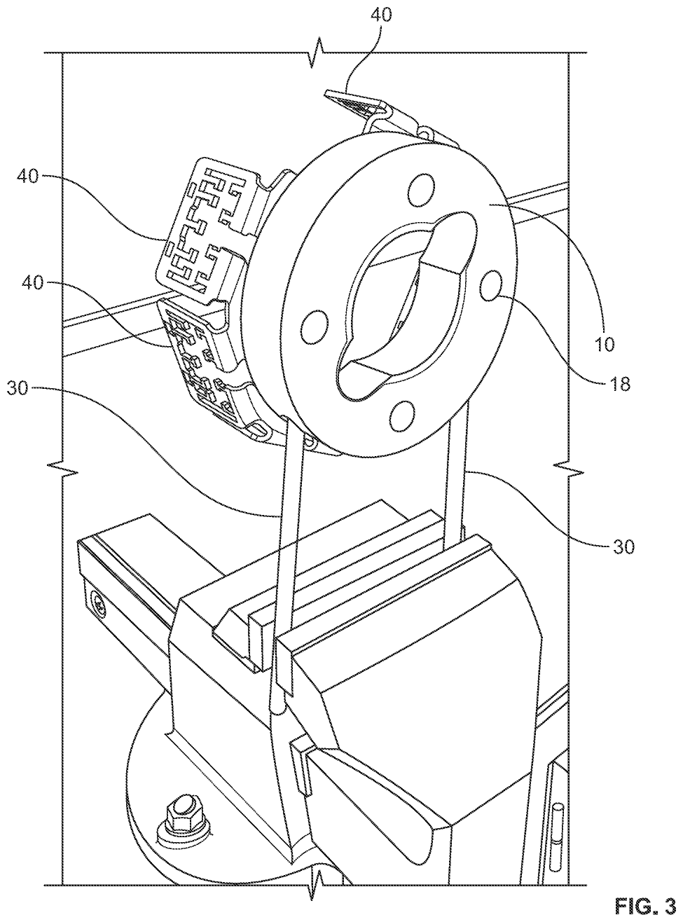

As shown in FIG. 3, the base interface can also be mounted horizontally with different positioning of support rods 30. Such an arrangement allows flexibility for the installer who is assembling the closure and the cables. The installer can choose to work on the closure in a horizontal position or in a vertical position, or another orientation such as angled if desired.

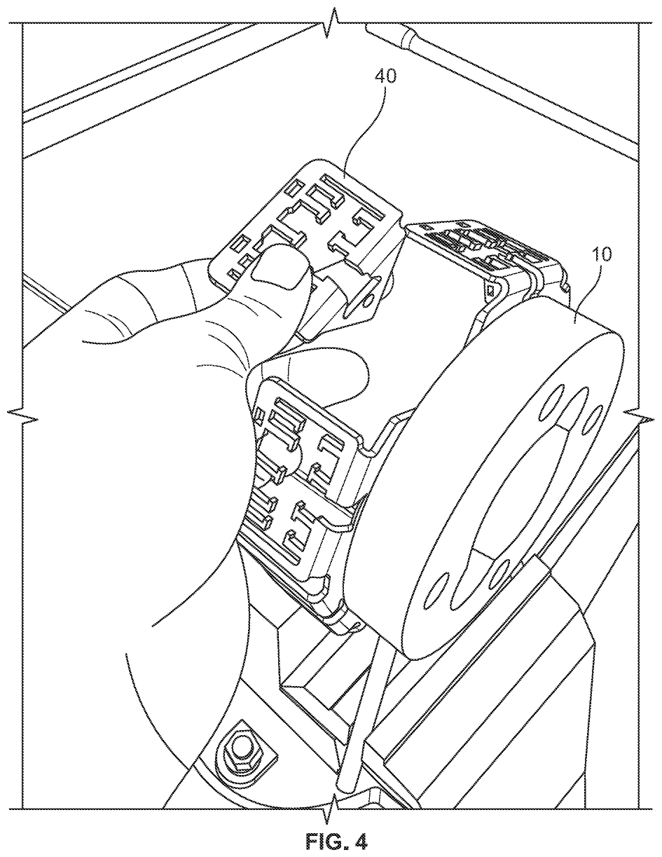

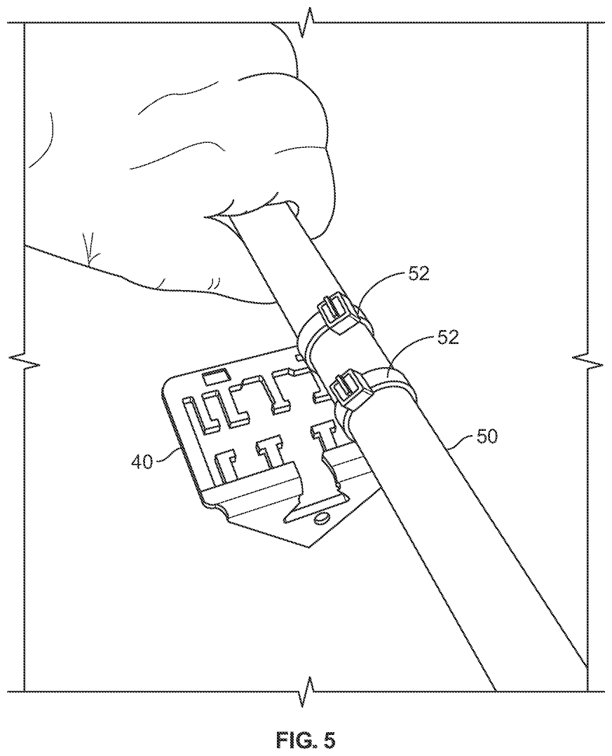

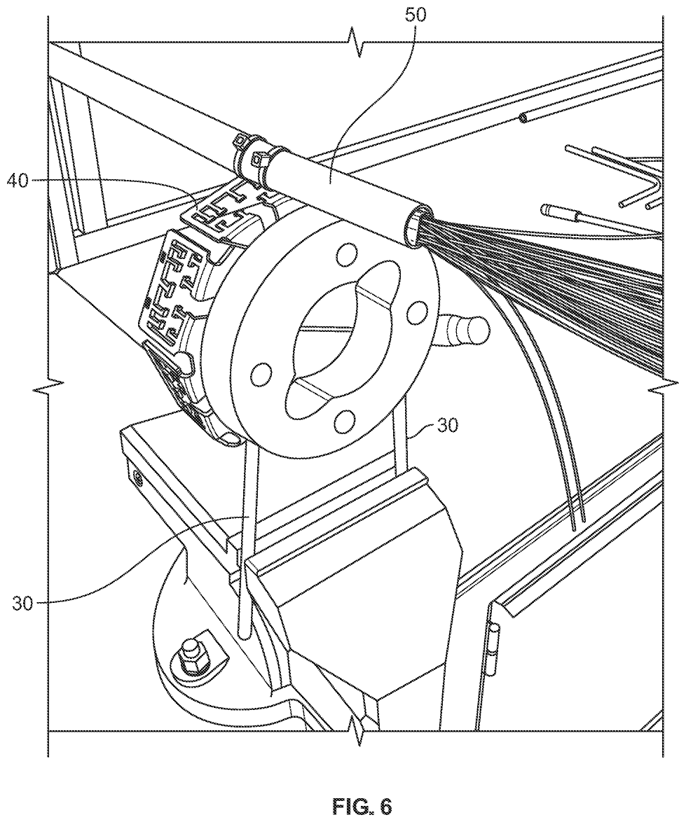

Referring to FIGS. 4-6, one of the cable mounting brackets 40 is shown being mounted to a cable 50. In this example, cable 50 is mounted to cable mounting bracket 40 with a plurality of cable ties 52. Cable 50 is a jacketed fiber optic cable, with fibers inside, and also one or more strength members, and possibly one of more tubes containing various numbers of optical fiber. Some fibers are accessed for connection to other fibers within closure 60, or they may be looped through to another closure or device. Once the cable 50 is mounted to the bracket 40, the bracket can be mounted to base interface 10. Additional cables can be mounted to bracket 40, or other brackets on base interface 10. The technician can work on the cable attachment to the mounting bracket 40, and then work on the mounting bracket 40 to the base interface 10 with easier access, since the closure structure is not yet present in one example.

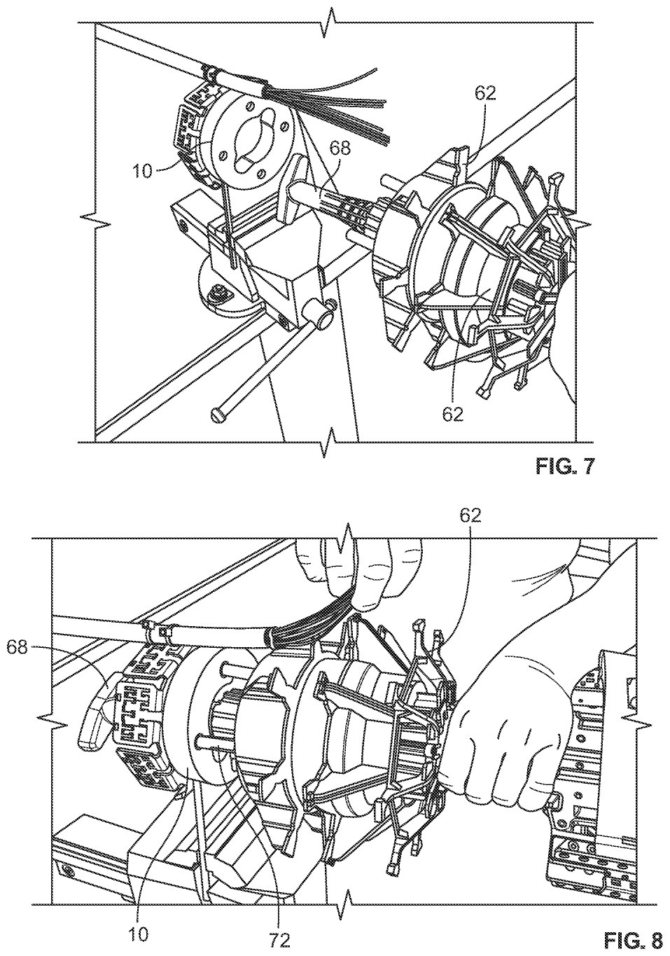

As shown in FIGS. 7 and 8, interior elements 62 of closure 60 are able to be separately mounted to base interface 10. One mounting arrangement is with posts 72 from the interior elements mounting to mounting openings 18 such as with fasteners. Interior elements 62 include a seal 64 for sealing the cables relative to an interior of the closure 60.

Interior elements 62 also include cable management devices for mounting and/or routing of the individual cables to the interior of closure 60. Base interface 10 includes a center opening 22 for receiving the actuator 68 of closure 60 as shown in FIGS. 7 and 8. Actuator 68 controls the sealing and unsealing of the closure. Interior elements 62 of closure 60 can include such items as cables, cable mounts, cable routing managers, loop storage, splices, splitters, and cable connectors and adaptors. Interior elements 62 of closure 60 can also include hingable trays containing one or more of cable slack, splices, splitters or other telecommunications components.

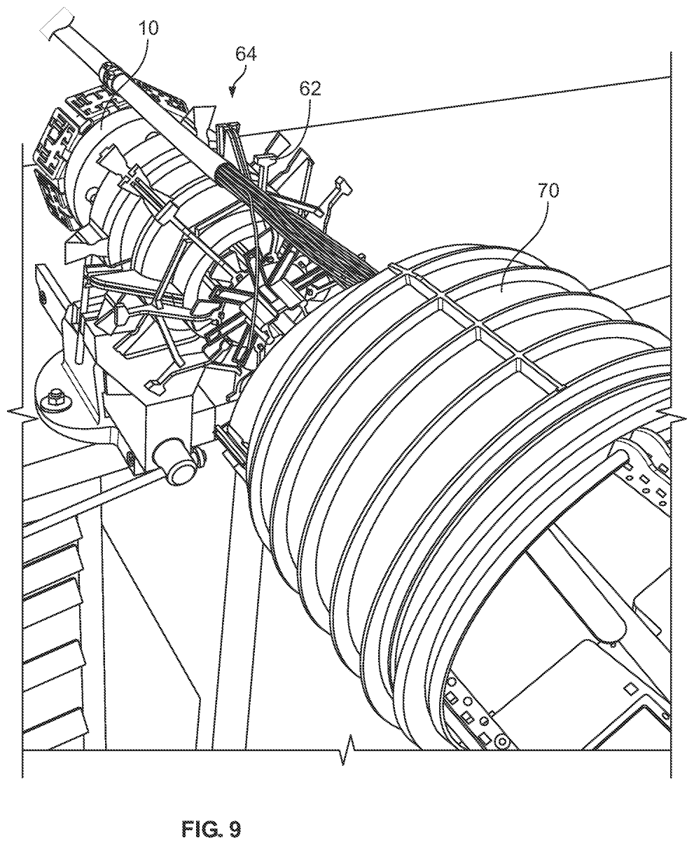

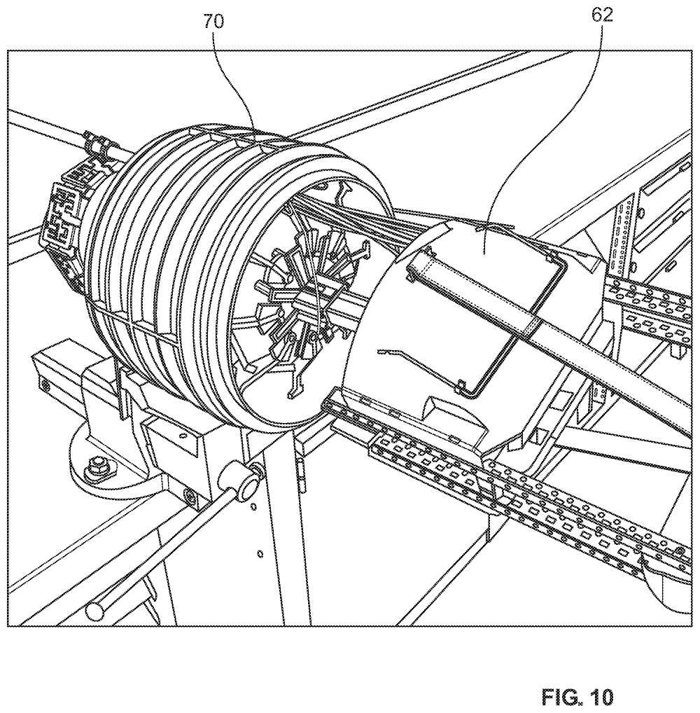

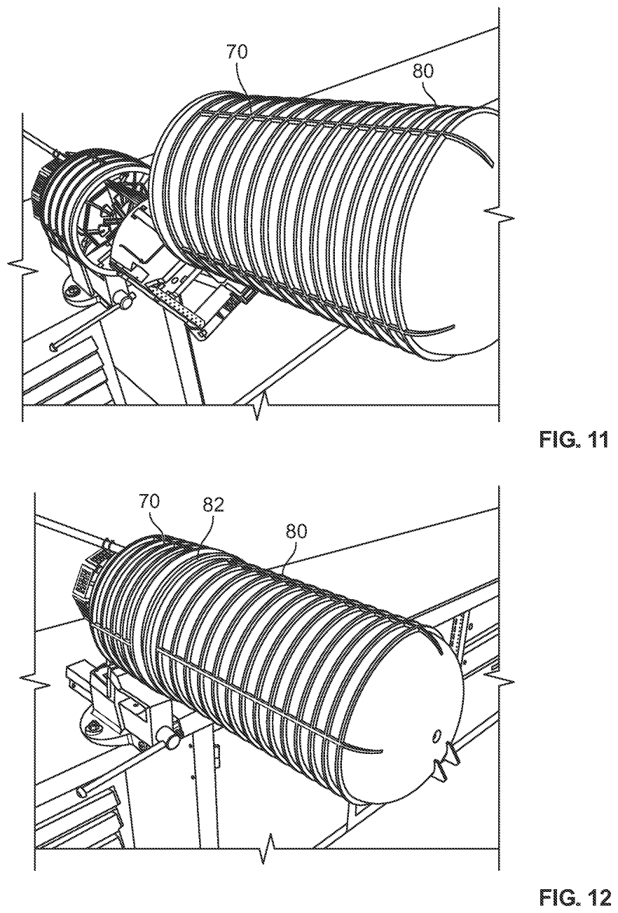

In FIGS. 9 and 10, base 70 of closure 60 is shown being mounted over interior elements 62. In FIGS. 11 and 12, a dome cover 80 is shown being mounted over interior elements 62 and then connected to base 70, such as with a clamp or strap 82. Closure 60 can have a variety of shapes, structures and internal components. The seal 64 and an example incoming cable 50 is shown. The internal telecommunications cables and connectivity components such as fiber optic splice trays, splitter trays or fiber optic connectors and mating adapters are shown. Commercial closures of the type illustrated include FIST style and FOSC style closures available from CommScope, Inc. of North Carolina, USA. An example closure of the type described above is shown U.S. Pat. No. 8,989,550, the disclosure of which is hereby incorporated by reference. A further example closure of the type described above is shown in WO2018/234579, the disclosure of which is hereby incorporated by reference. The closure of WO2018/234579 closely resembles the closure 60 of the Figures.

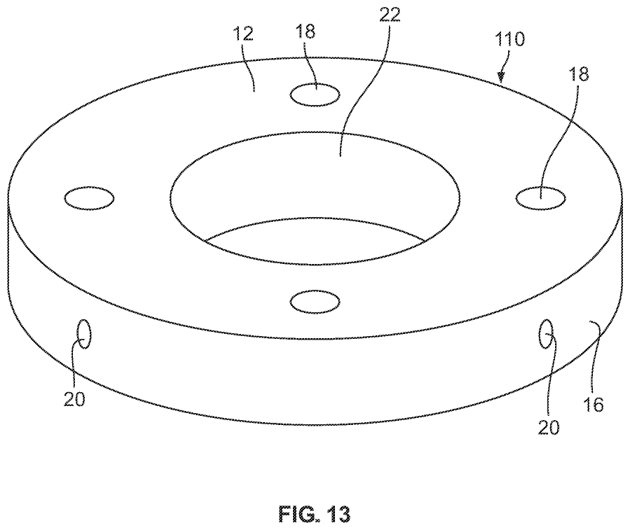

Referring now to FIG. 13, an additional embodiment of base interface 110 similar to base interface 10 is shown including the center opening 22, the mounting openings 18 for connecting to the closure 60, and the two side openings 20 for mounting to the support rods 30 or other rods.

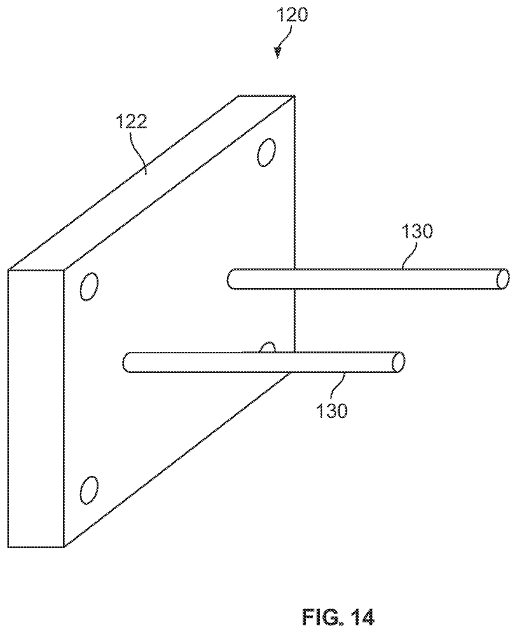

FIG. 14 shows a mounting bracket 120 for use as a workstand or a permanent mounting structure including similar support rods 130.

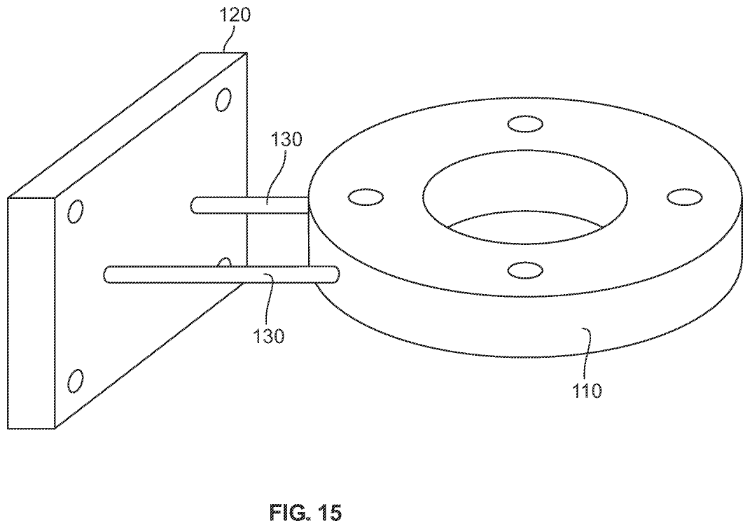

FIG. 15 shows the base interface 110 mounted to the support rods 130 of the mounting bracket 120 of FIG. 14.

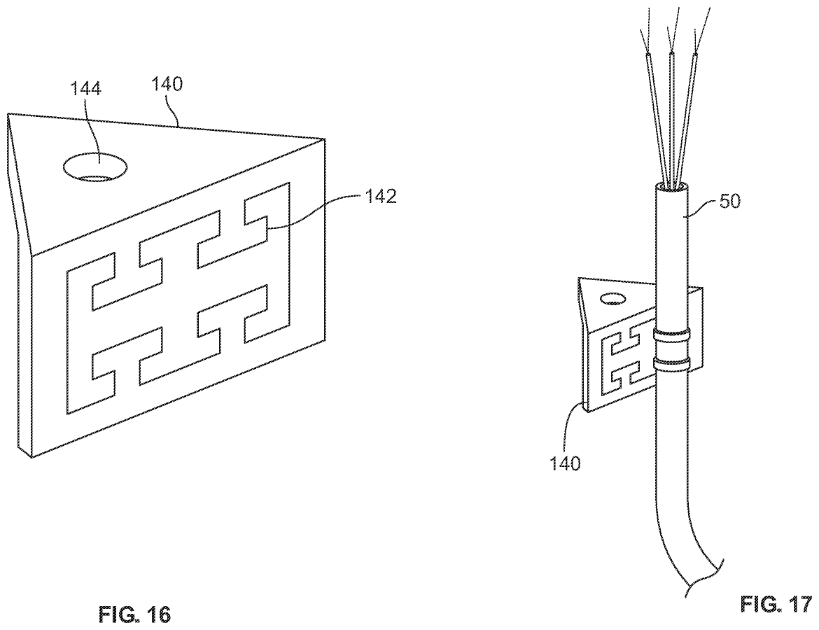

FIGS. 16 and 17 show another example cable mounting bracket 140 and a cable 50 being mounted to the cable mounting bracket 140. Cable mounting bracket 140 includes structure such as T tabs 142 to enable cables 50 to be mounted with cable ties 52, such as zip ties. Cable mounting bracket 140 includes a mounting hole 144 for mounting to the lower surface of base interface 110 such as with a fastener.

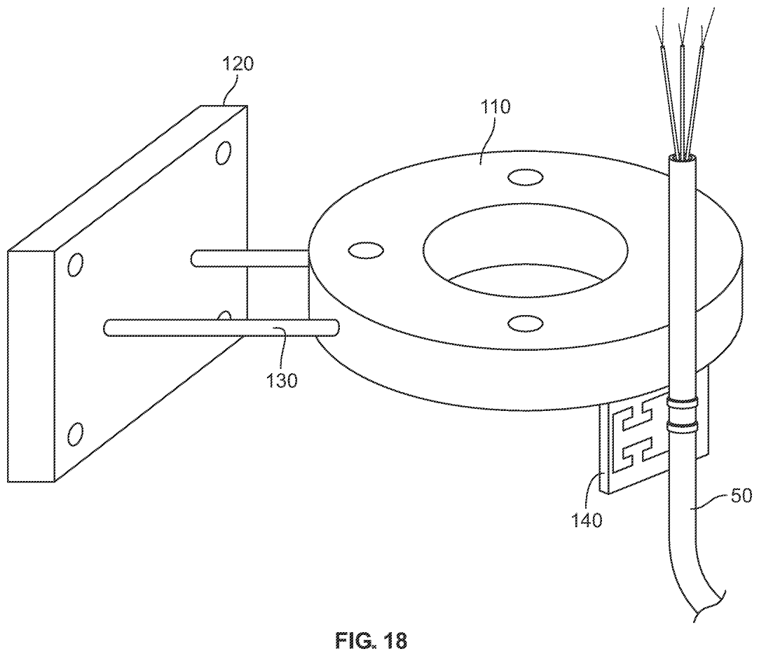

FIG. 18 shows the example cable mounting bracket 140 and cable 50 of FIG. 17 being mounted to the base interface 110.

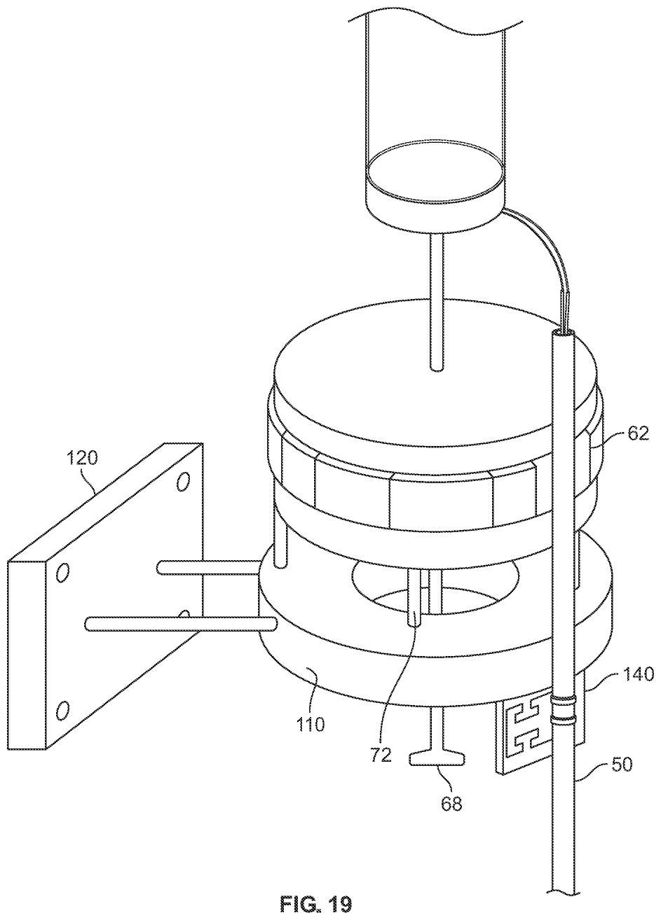

FIG. 19 shows the interior elements 62 of closure 60 being mounted to the base interface 110.

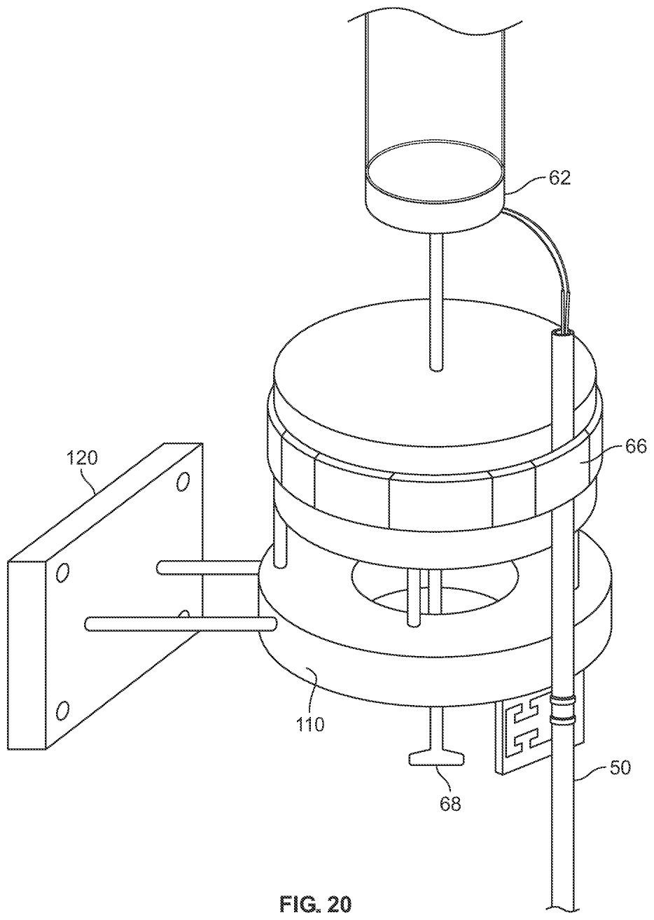

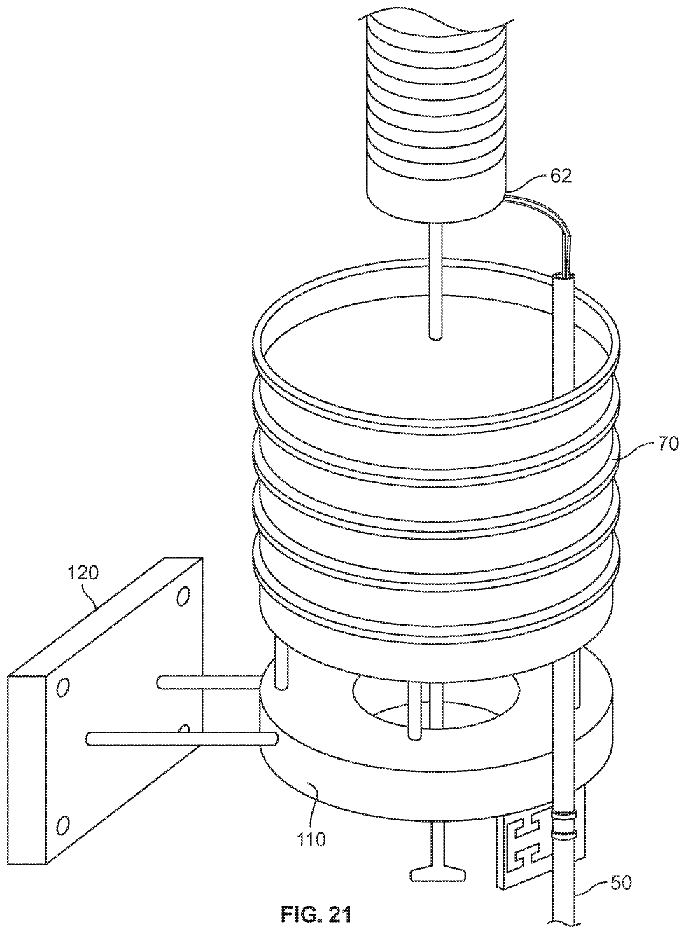

FIG. 20 shows a gel sealing element 66 being positioned over the cable 50.

FIG. 21 shows the base 70 mounted over a lower portion of the interior elements 62.

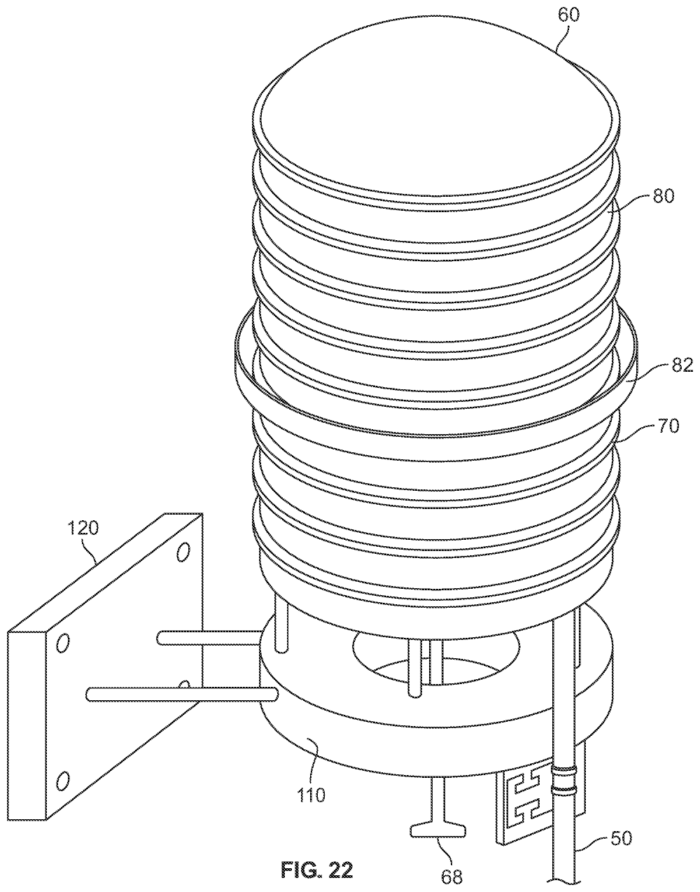

FIG. 22 shows the dome cover 80 being mounted to the base 70, and connected with a strap 82, to form closure 60.

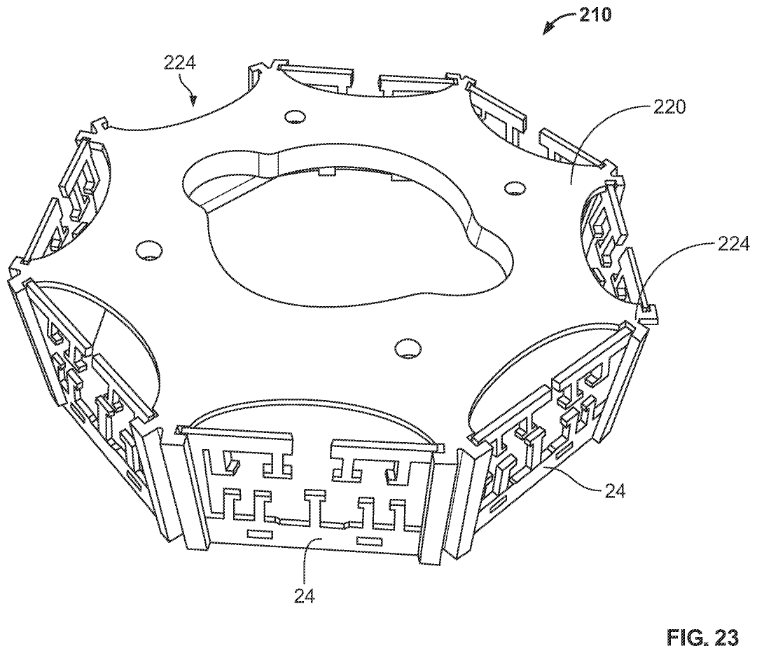

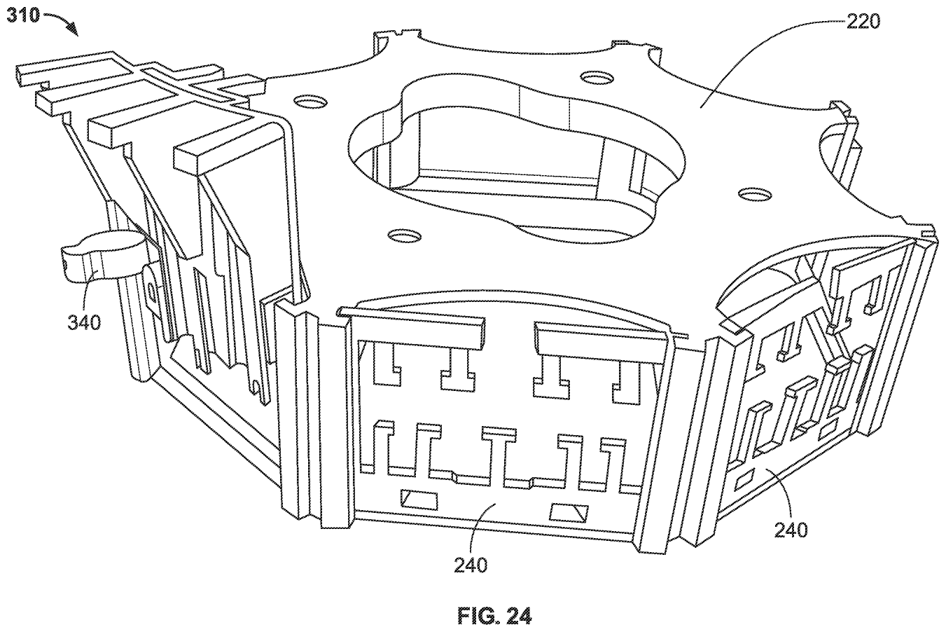

FIG. 23 shows an alternative embodiment of a base interface 210, which includes a plate 220, and side mounts 224 for the mounting brackets 240. FIG. 24 shows the alternative embodiment of the base interface 310 with plate 220 of FIG. 23, with a different cable mounting bracket 340 in one of the bracket mounting locations.

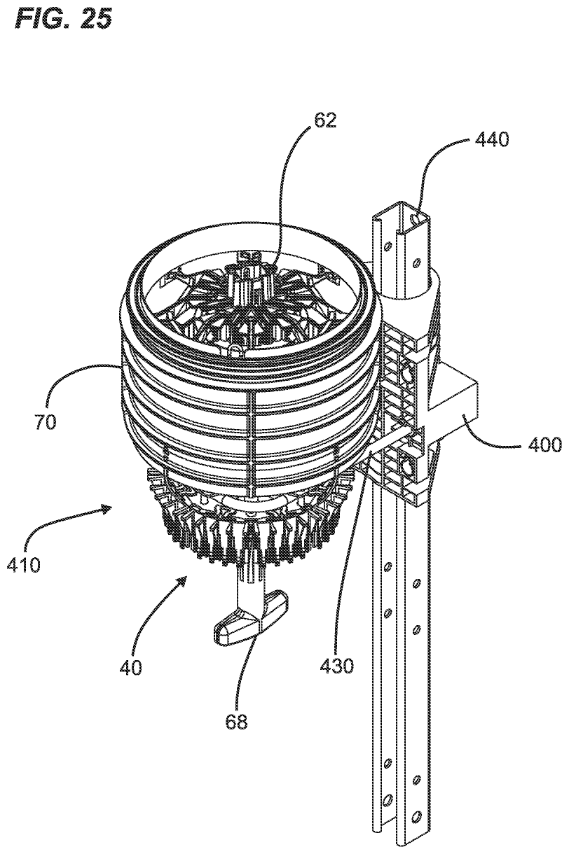

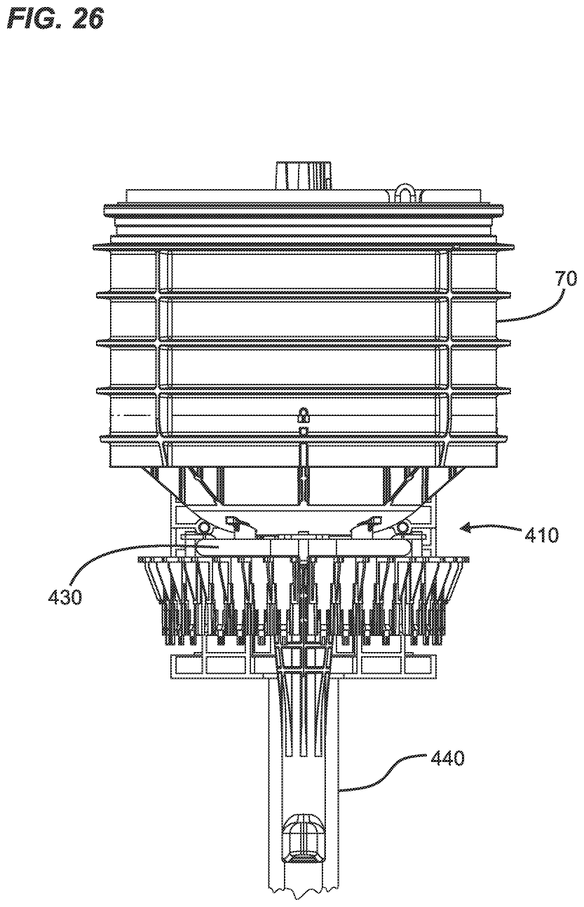

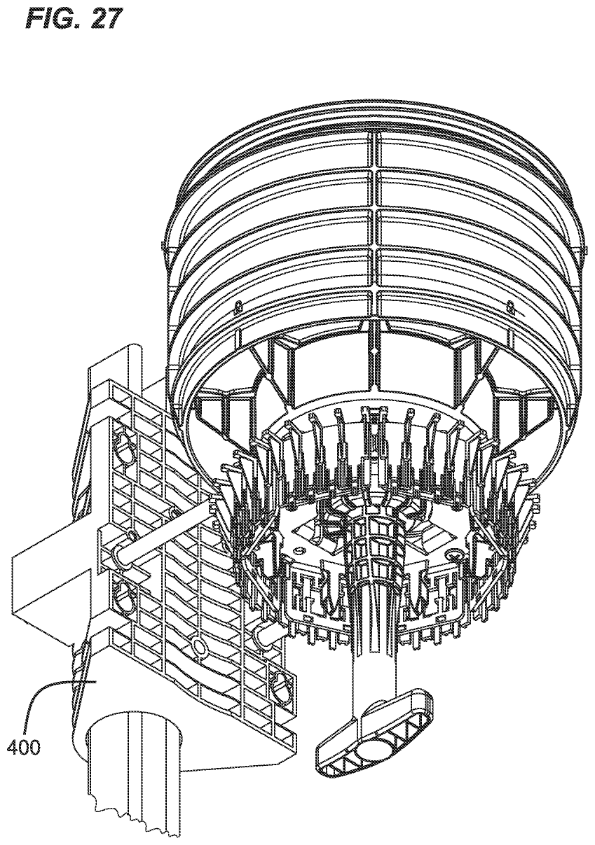

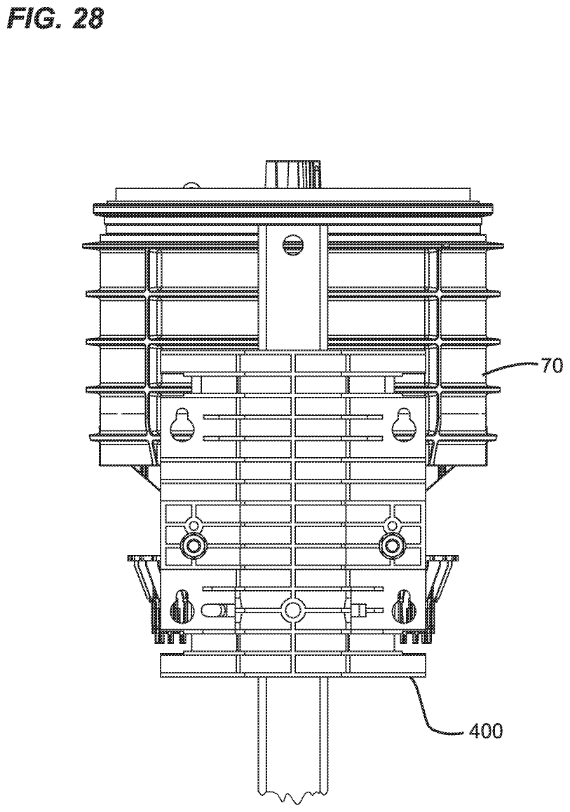

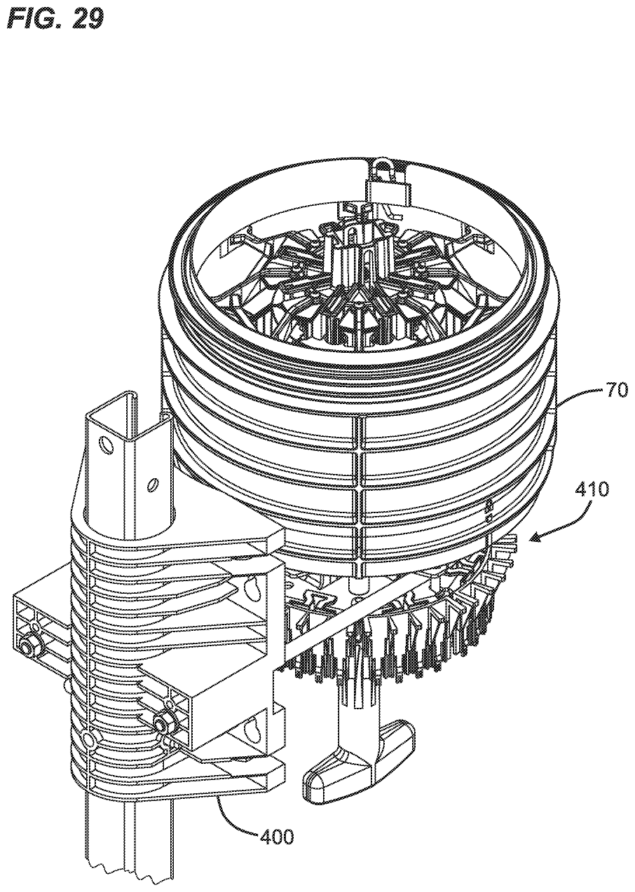

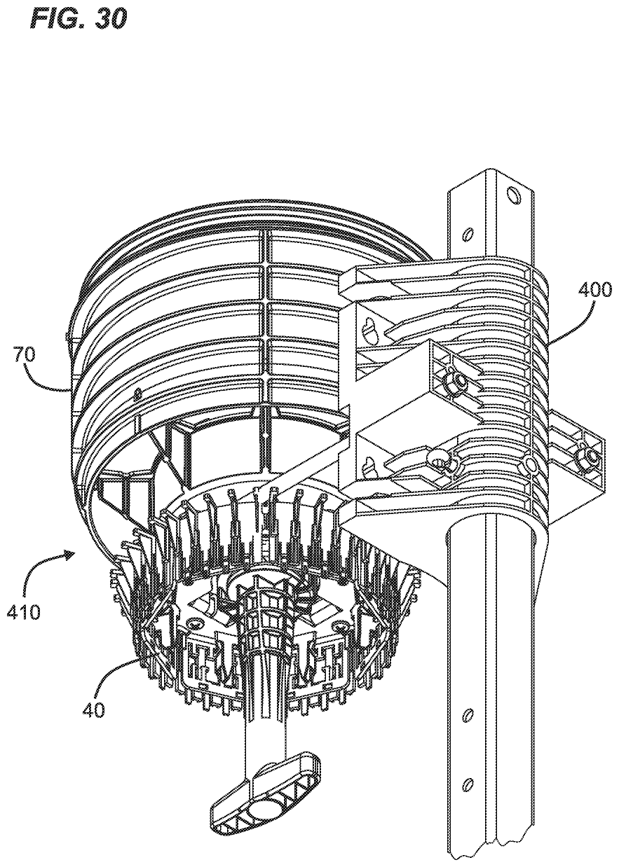

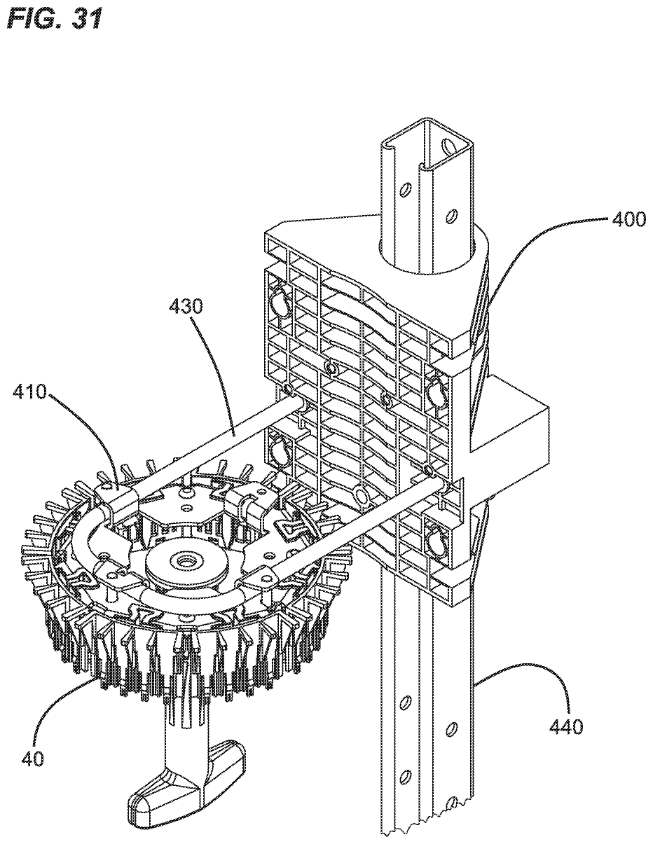

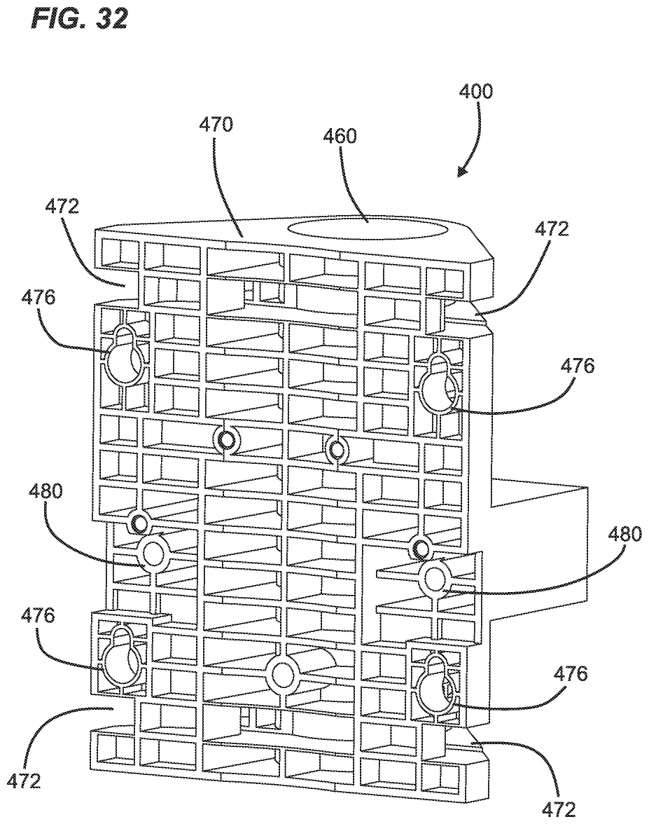

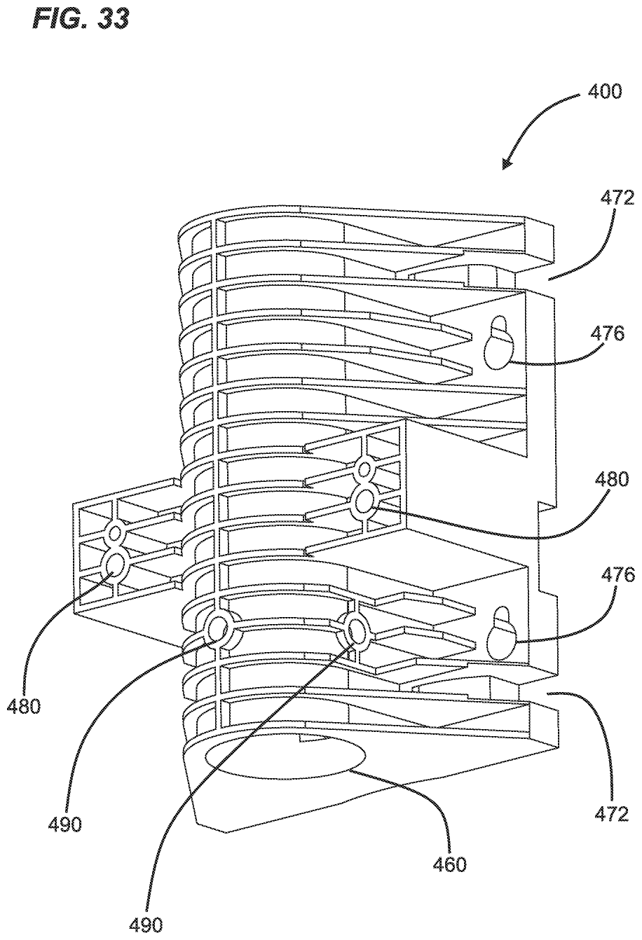

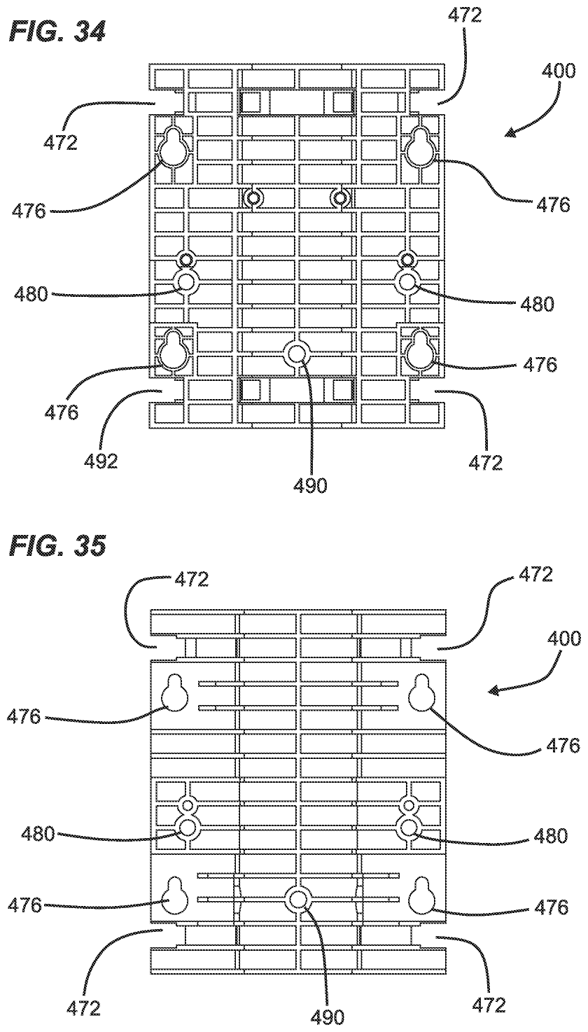

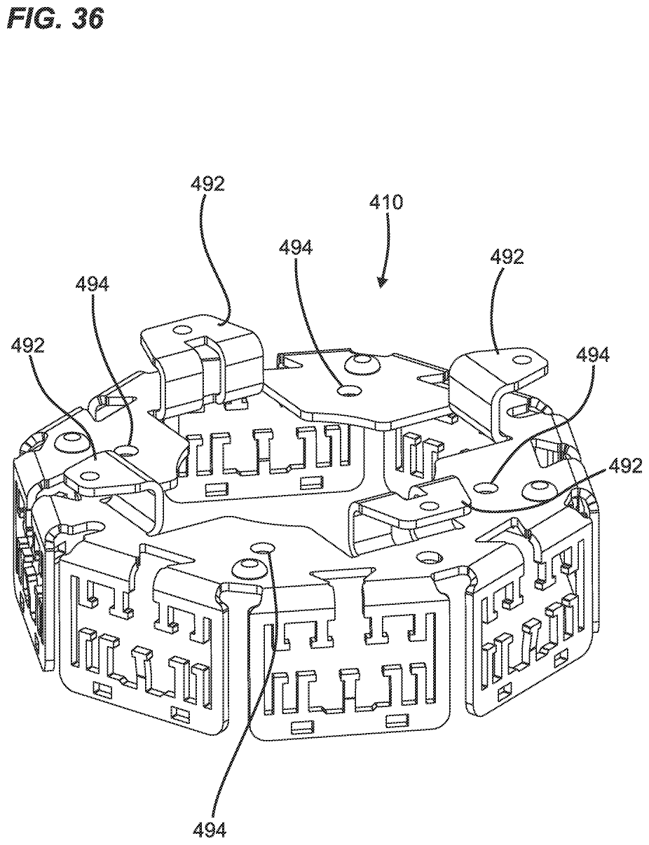

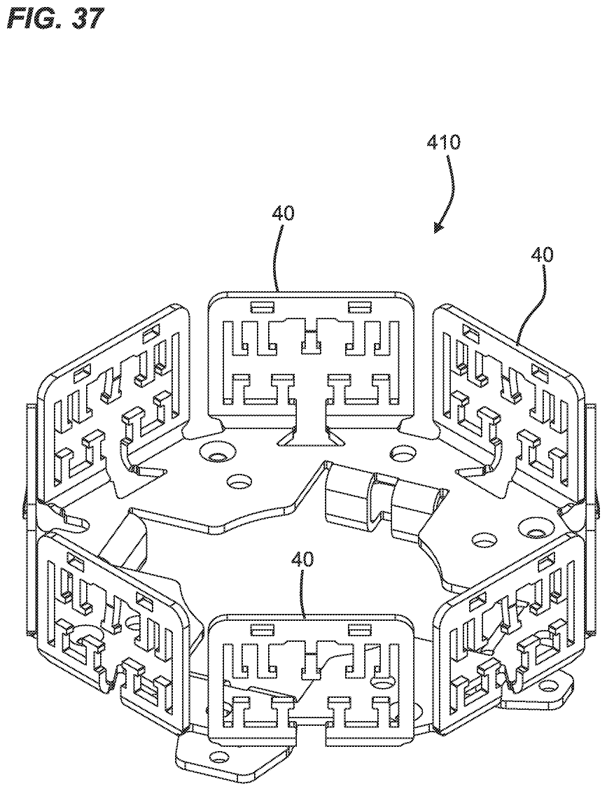

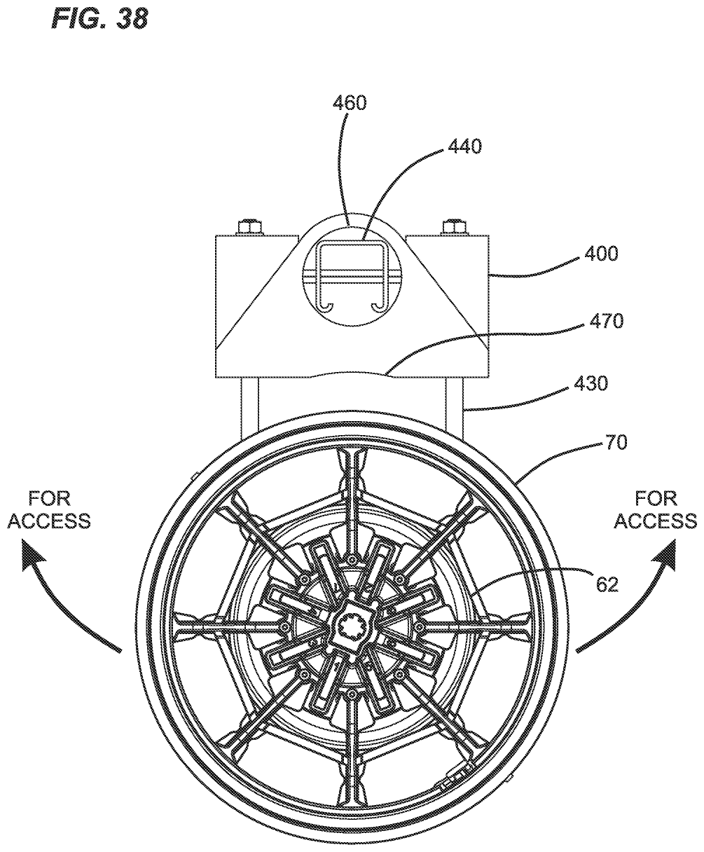

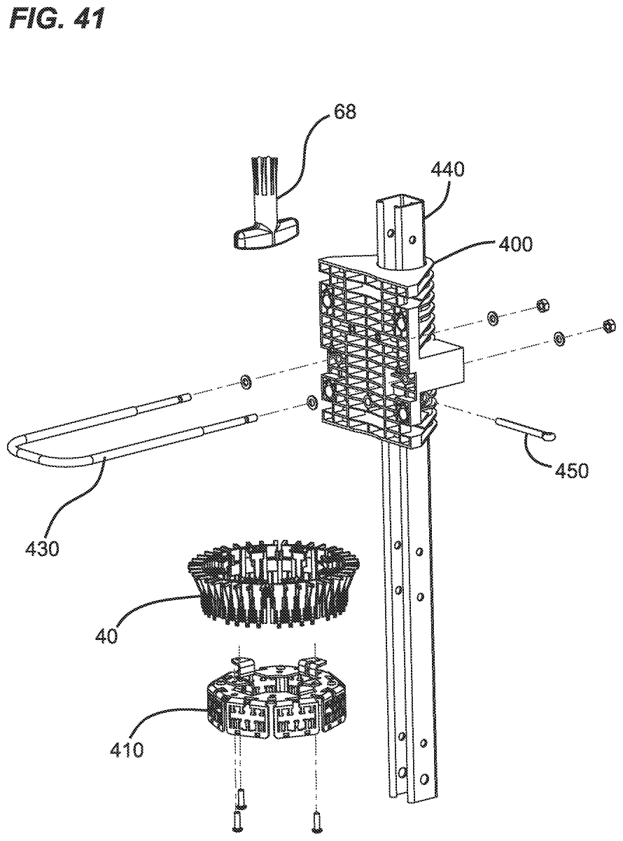

FIGS. 25 through 41 show an alternative embodiment of a base interface 410 which is mountable with U-shaped rods 430 to a support device 400. Support device 400 is mounted to a U-shaped channel or projection 440. U-shapes 492 receive the rod 430 and secure it with a fastener. Holes 494 secure base interface 410 to interior elements 62.

A pin 450 mounts support device 400 to U-shaped projection 440. Support device 400 includes a cylindrical opening 460 extending in an axial direction parallel to an axial direction of the inner elements of the closure. Cylindrical opening 460 can rotate as desired (once no longer fixed with pin 450) about u-shaped projection 440.

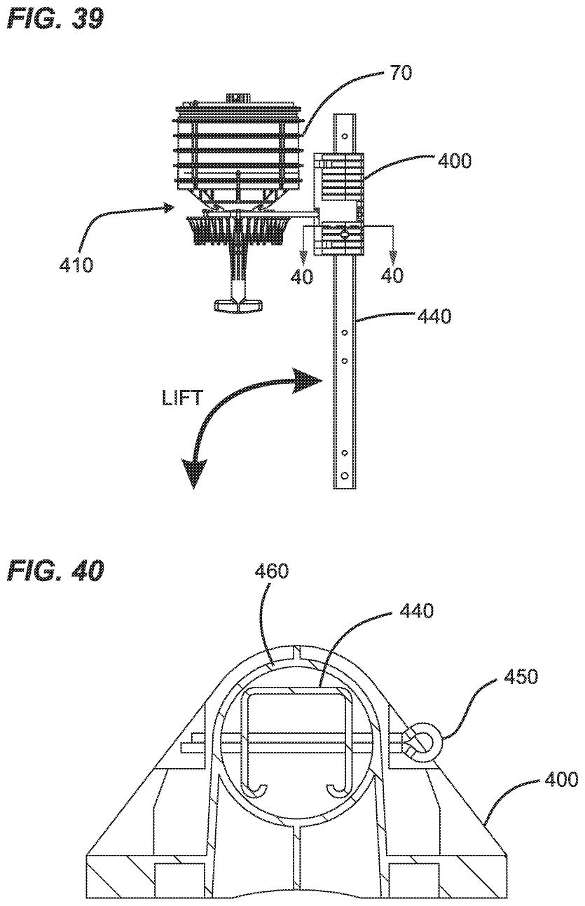

U-shaped projection 440 can be stationary or movable. In one example, it is rotatable into and out of an underground location. Projection 440 can rotate upwardly as shown in FIG. 39 for a technician to work on the closure interior elements. In some cases, support device can either or both lift and rotate relative to projection 440 to facilitate easier technician access. Pin 450 as described below and shown in the figures allows for the technician to make the adjustments. Either pin 450 is received in a hole in projection of just below for the technician to work on the closure in a more convenient orientation besides the storage orientation on projection 440.

Support device 400 includes one or more features for mounting to other structures, such as a wall, a pole or a projection. In the example embodiment, the closure can be mounted to the front of support device 400 or the rear of support device 400. The rear of support device 400 can include a curved portion 470 to facilitate pole mounting. Strap cut outs 472 can be provided to facilitate a pole mount. Openings 476 in support device 400 facilitate a wall mount to fasteners. Openings 480 receive the ends of U-shaped rod 430 and mating fasteners (nuts) to secure base interface 410 to support device 400. Further openings 490 can receive a pin 450 to secure the closure in a certain orientation (vertical or rotational or both) relative to any inner mating device like U-shaped projection 440, or other device (see below for cylinder 800).

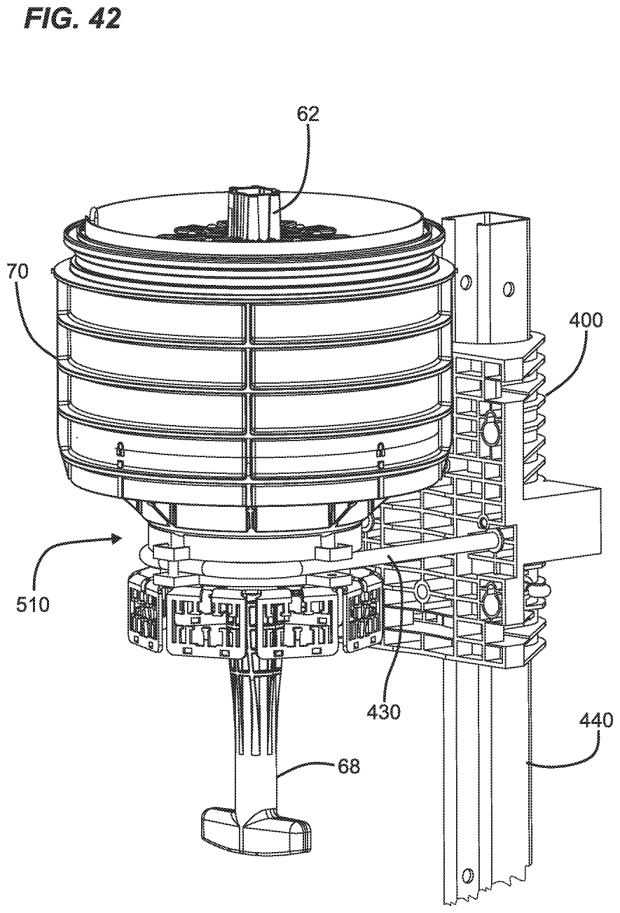

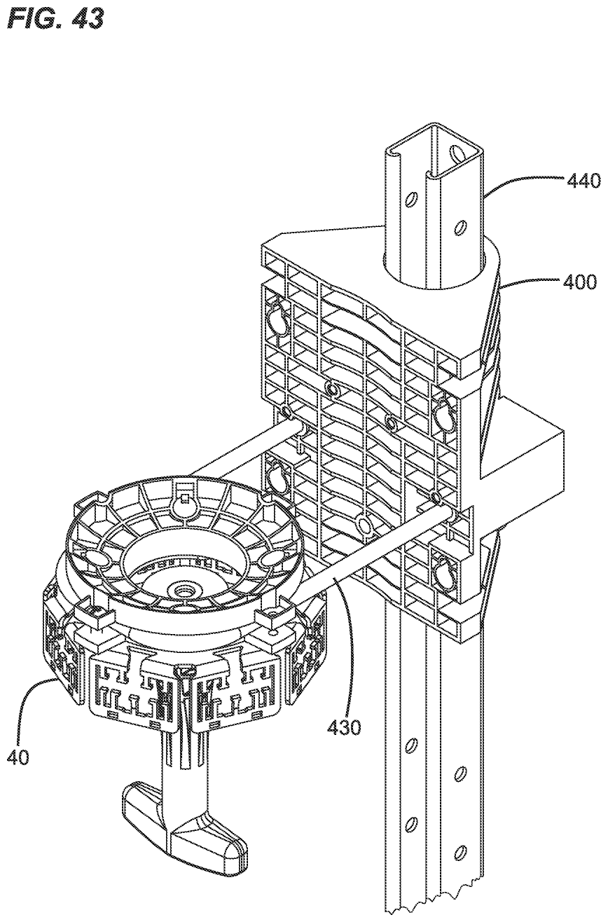

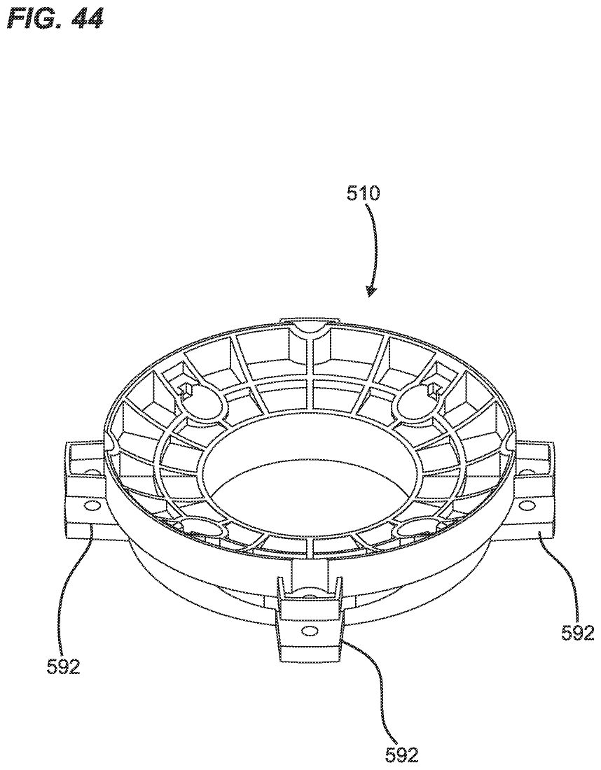

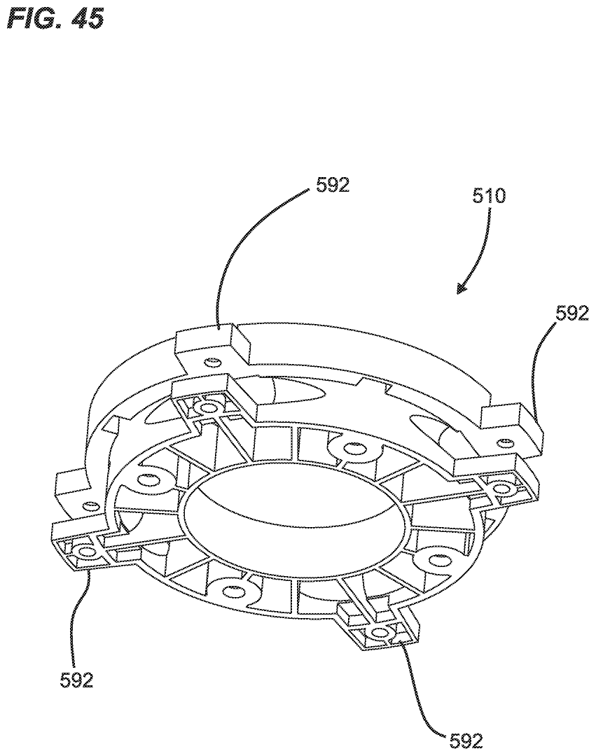

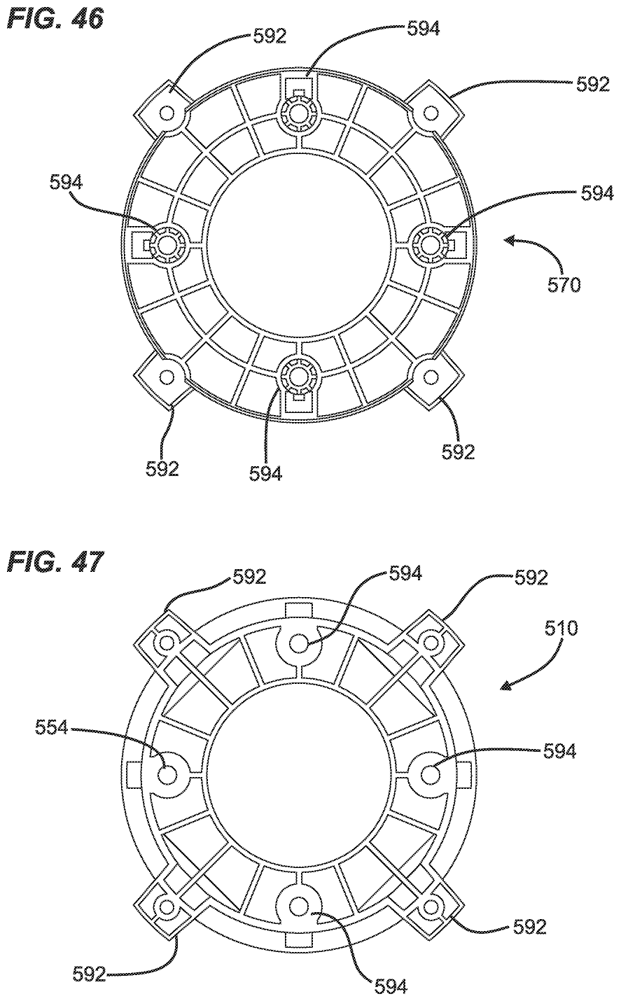

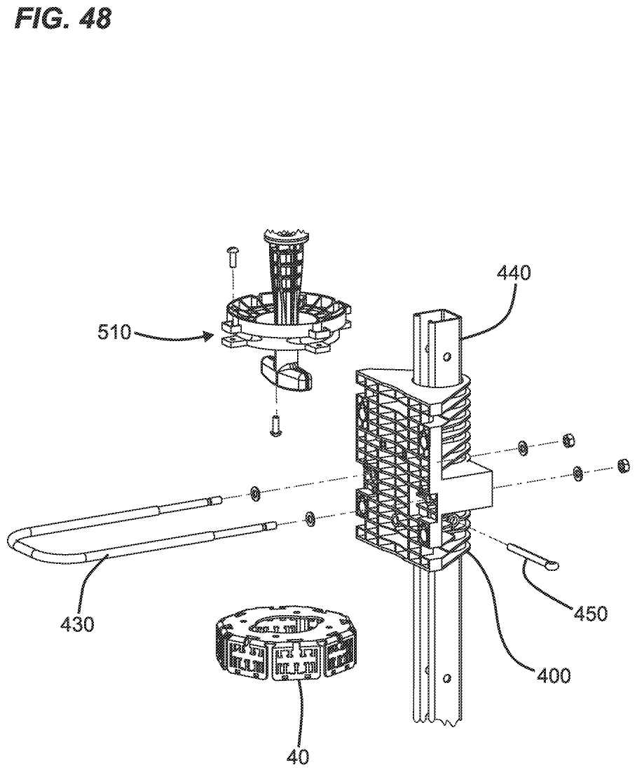

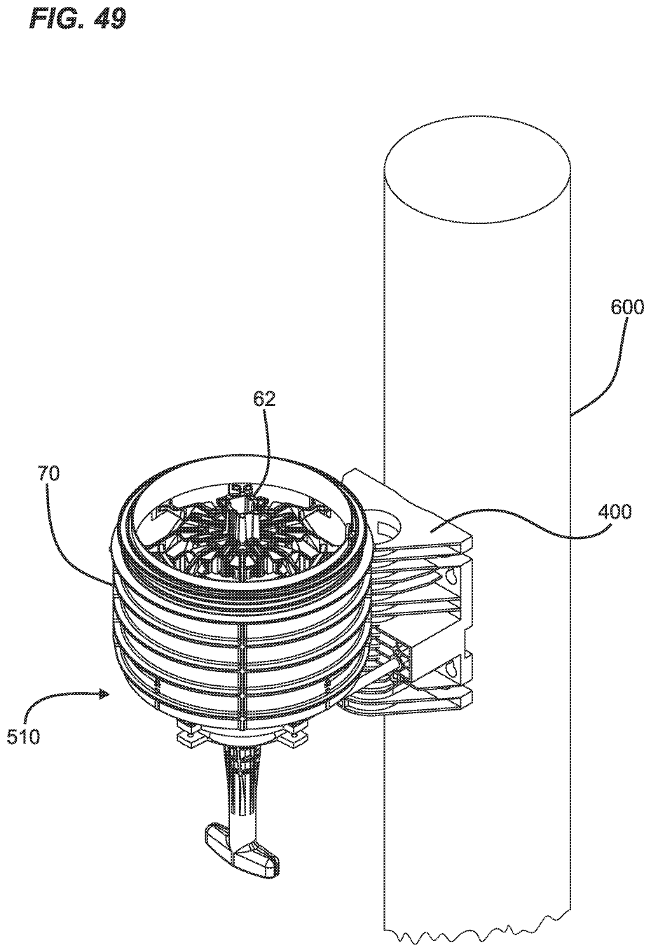

Referring now to FIGS. 42 through 48 an alternative embodiment of a base interface 510 is shown mountable with a U-shaped rod 430 to support device 400. Base interface 510 can be made from molded plastic, wherein base interface 410 can be made from sheet metal and include integral cable mounting brackets 40. Brackets 40 mount to base interface 510 with fasteners. U-shapes 592 receive the rod 430 and secure it with a fastener. Holes 594 secure base interface 510 to interior elements 62.

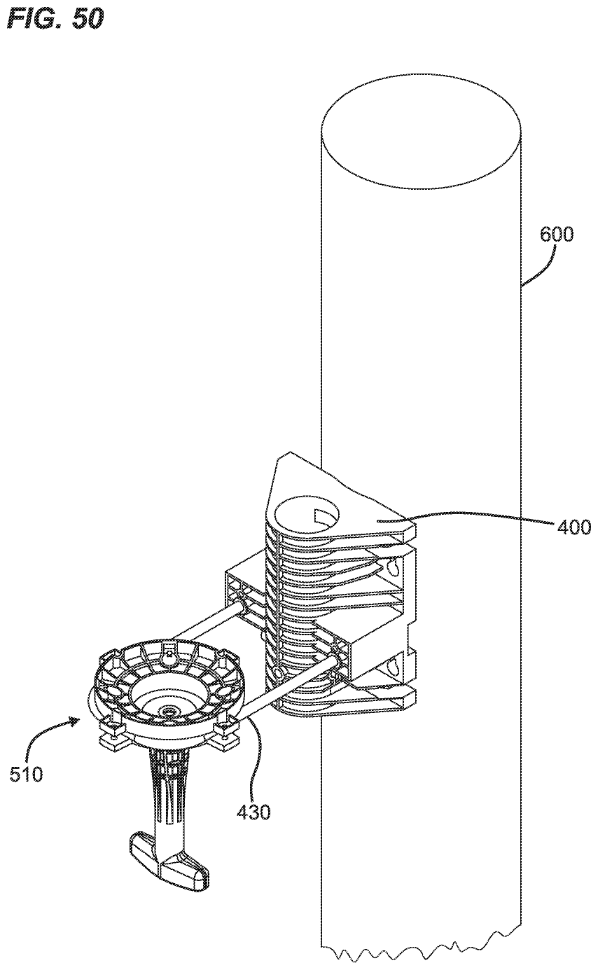

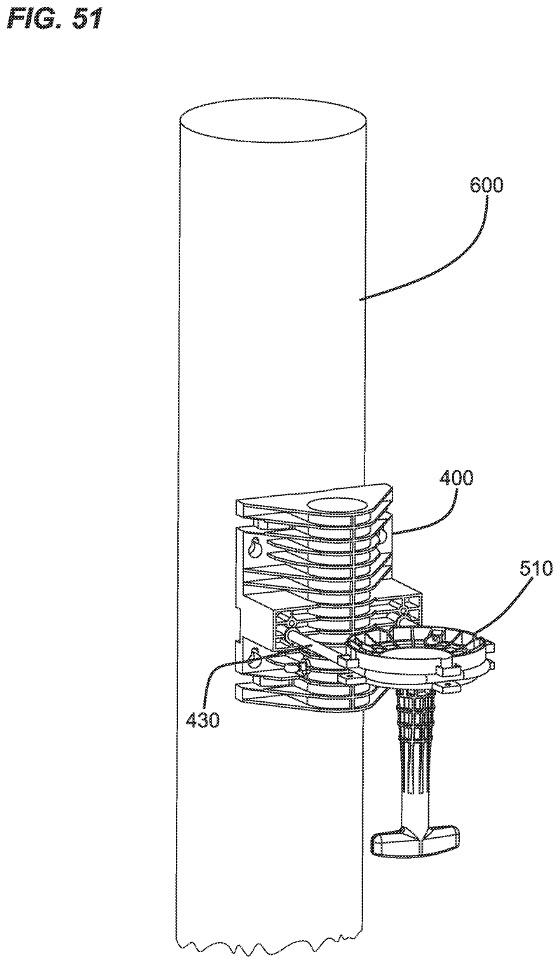

Referring now to FIGS. 49 through 51, the device shown in FIGS. 42 through 48 is mounted to a pole 600. Furthermore, base interface 510 is mounted to an opposite side of the support device 400 with the same U-shaped rod 430.

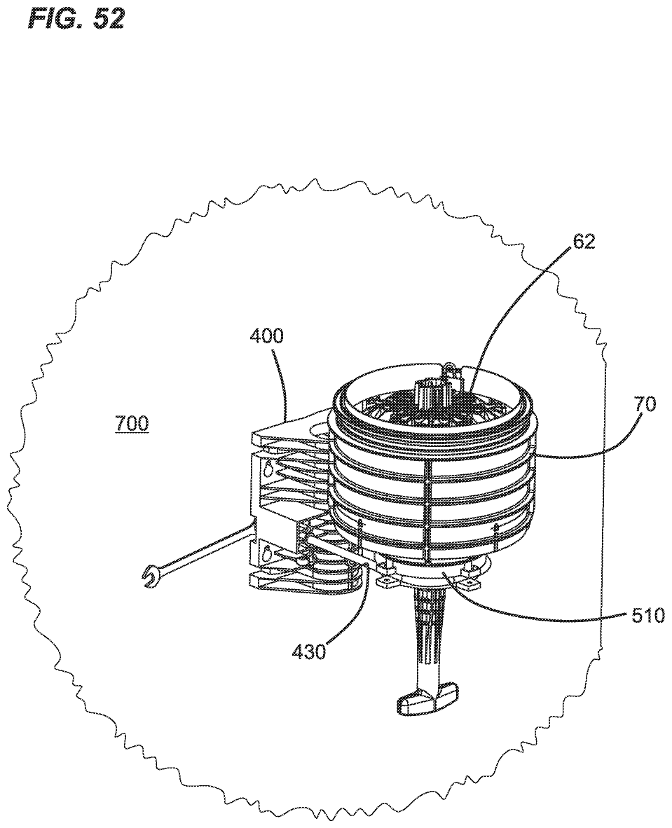

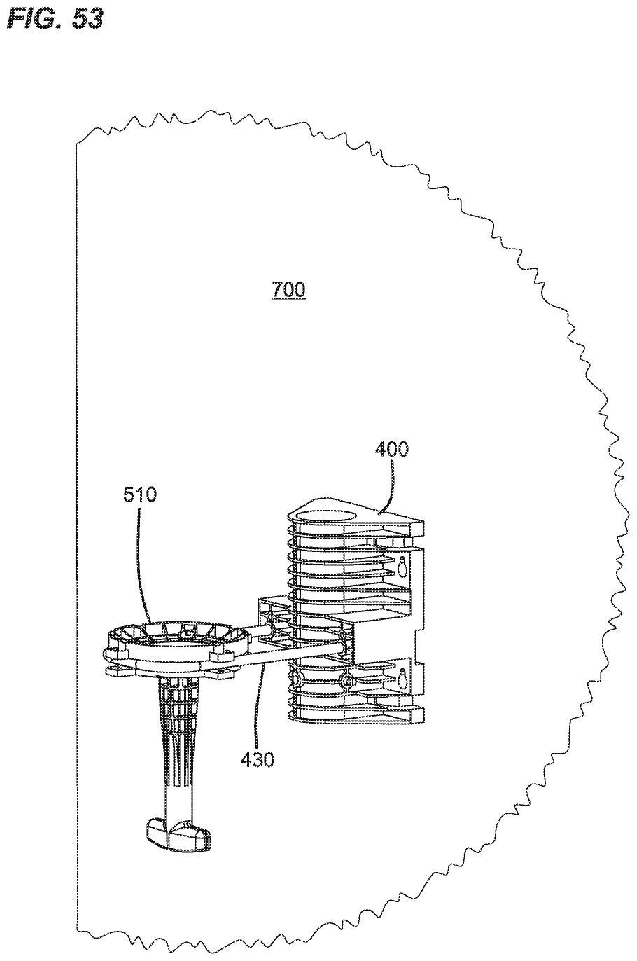

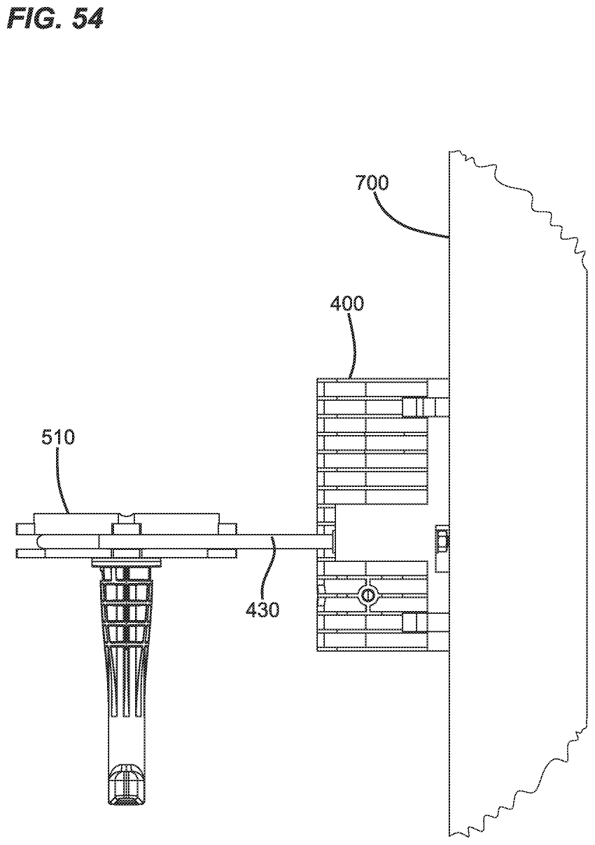

Referring now to FIGS. 52 through 54, the device of FIGS. 42 through 51 is shown mounted to a planar wall surface 700 utilizing various fasteners for mounting to the wall.

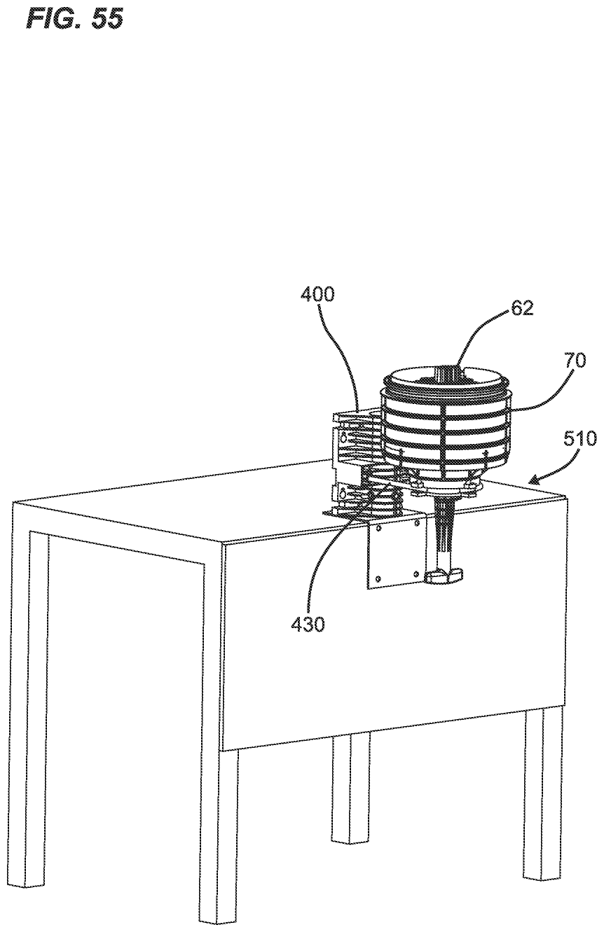

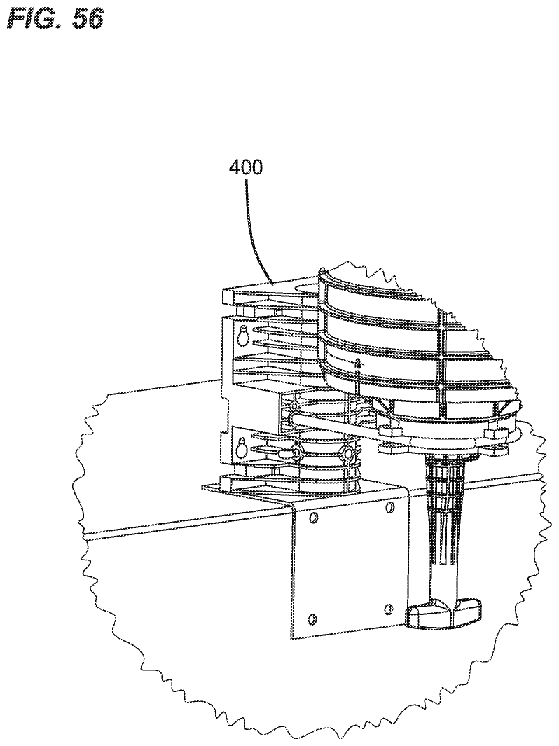

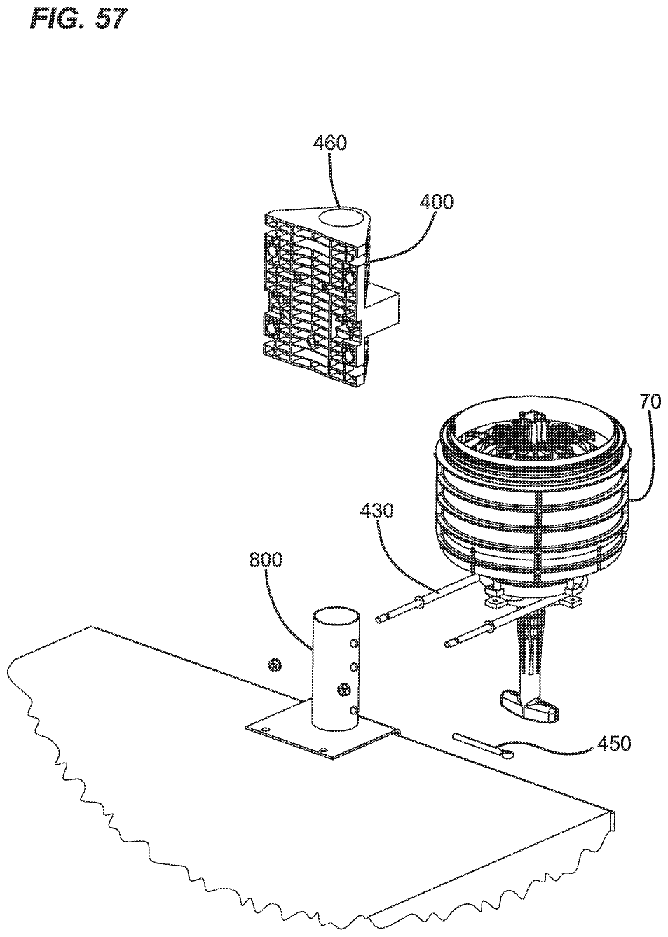

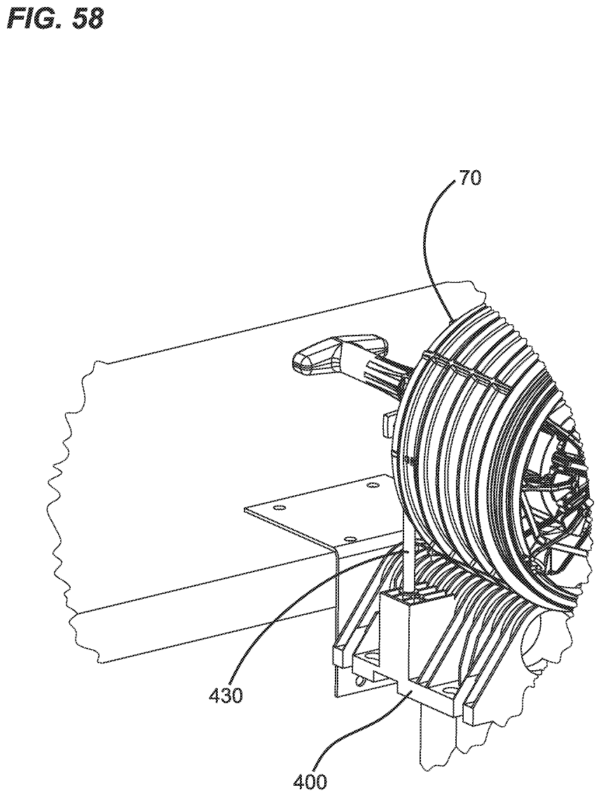

Referring now to FIGS. 55 through 58, the device shown in FIGS. 42 through 54 is mounted in a manufacturing or workstand arrangement for initial assembly or for working on the device for a repair. The workstand includes a cylinder 800 which is received in the cylindrical hole of support device 400. As shown in FIGS. 55 through 58, the cylinder 800 can be mounted vertically to arrange the closure in a vertical orientation, or horizontally. Cylinder 800 can have other shapes such as square in outer cross section.

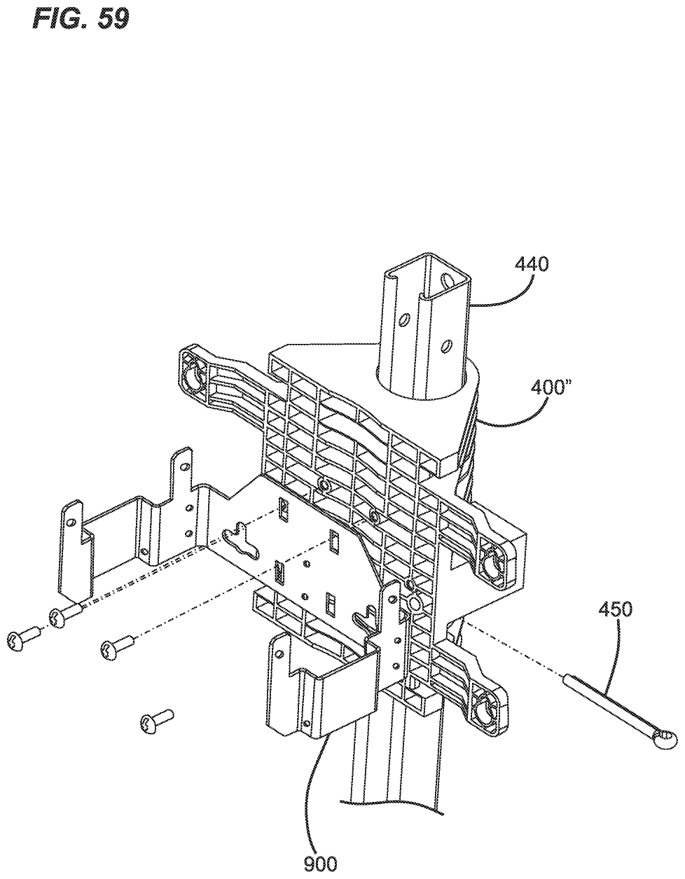

Referring now to FIG. 59, a different support device 400′ is shown, although similar in function to support device 400. Support device 400′ is shown mounted to a U-shaped projection 440 as in FIG. 42, but mounted to a support bracket 900 which interfaces with a different style closure. In this case, a TENIO style enclosure, manufactured and sold by CommScope, Inc., mounts to the support bracket 900.

In other example embodiments, U-shaped rod 430 is shown with a round cross-section. In some embodiments a rectangular cross-section can be utilized, if desired.

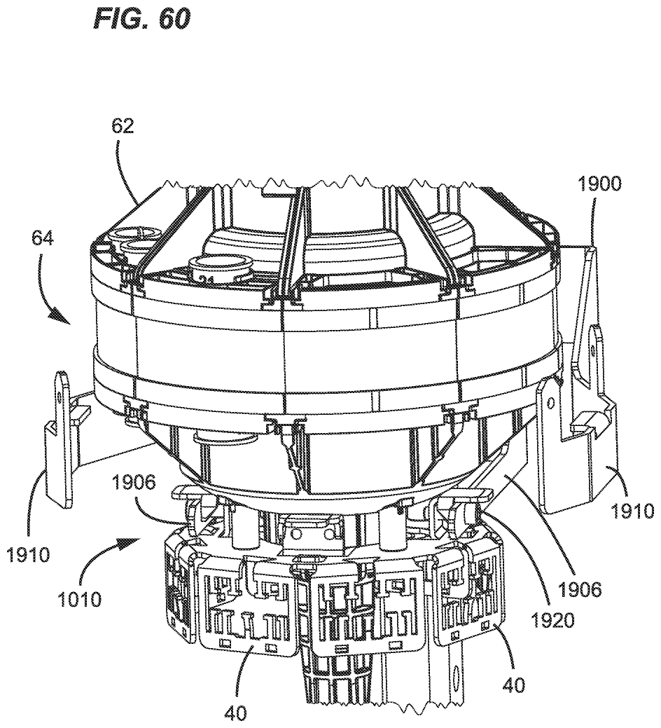

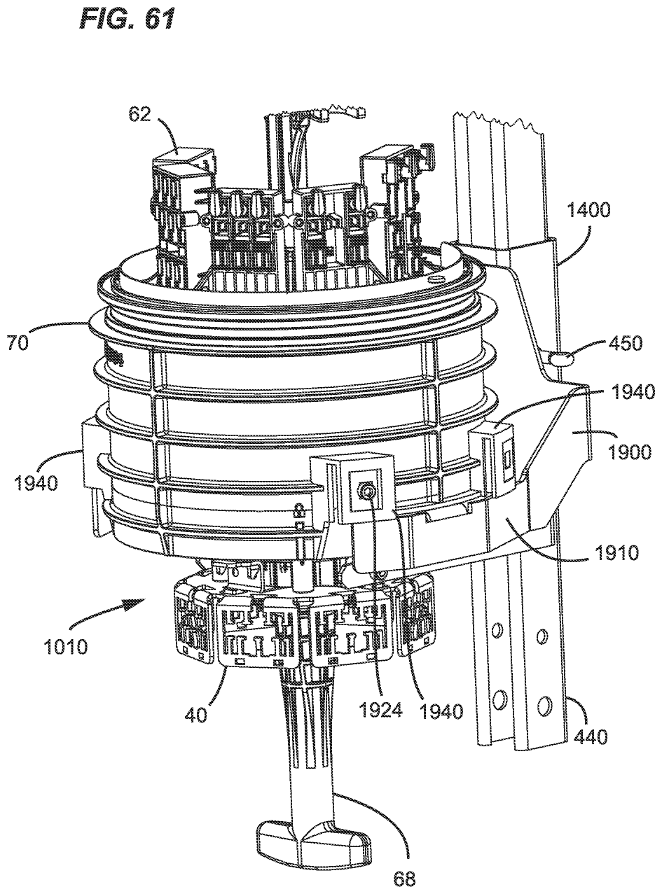

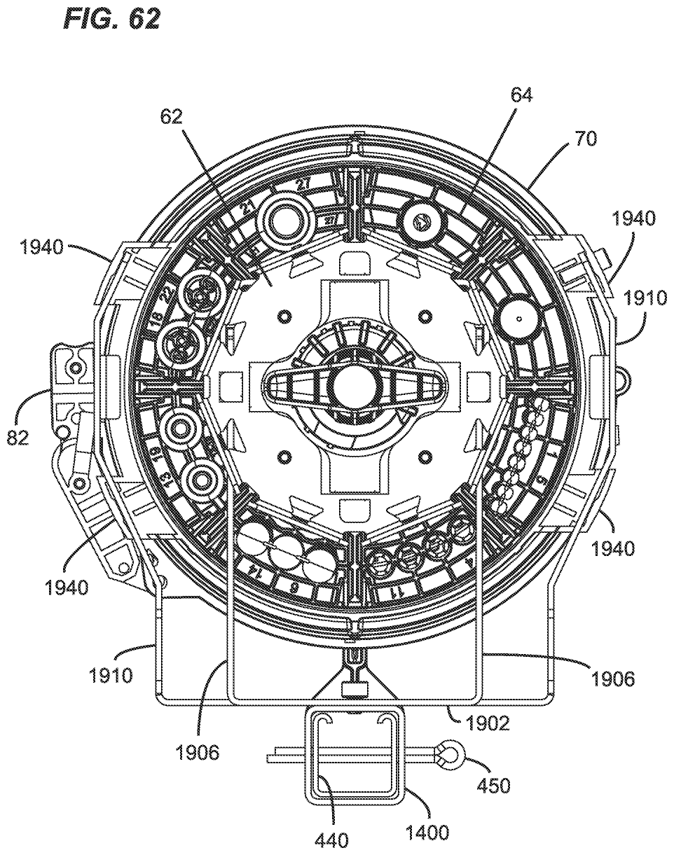

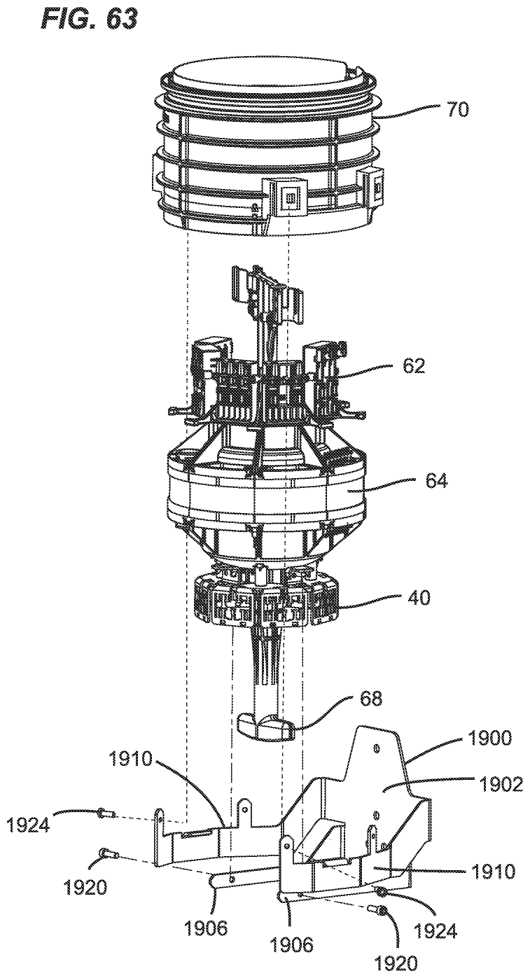

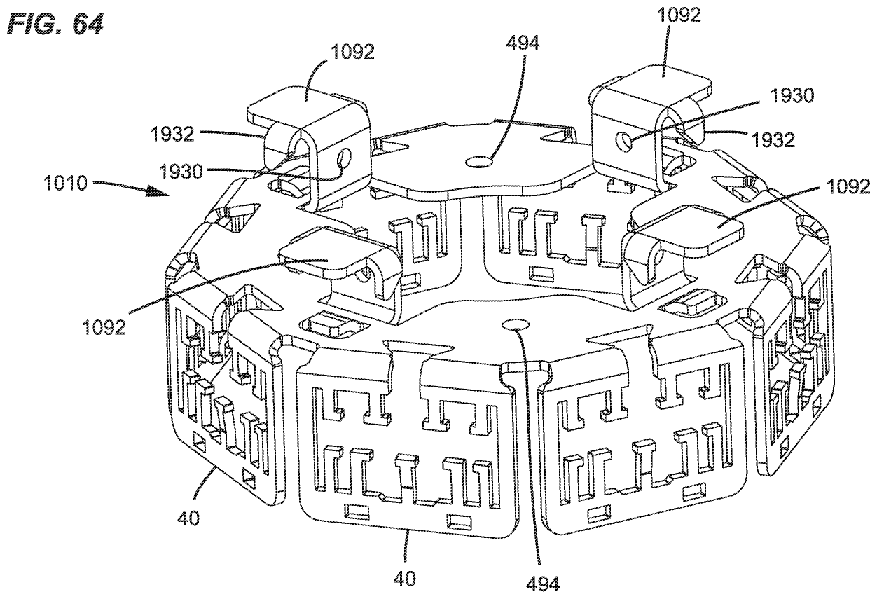

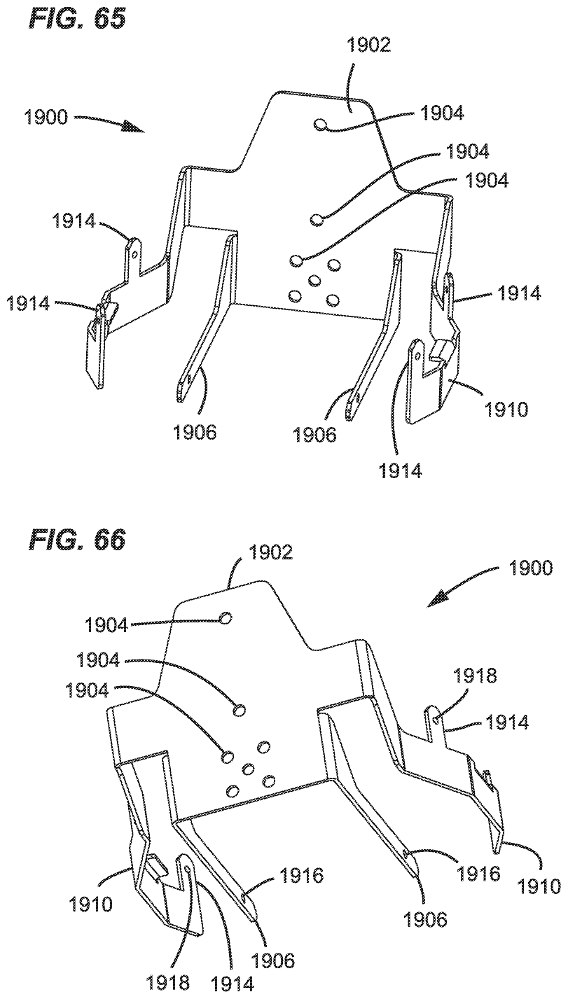

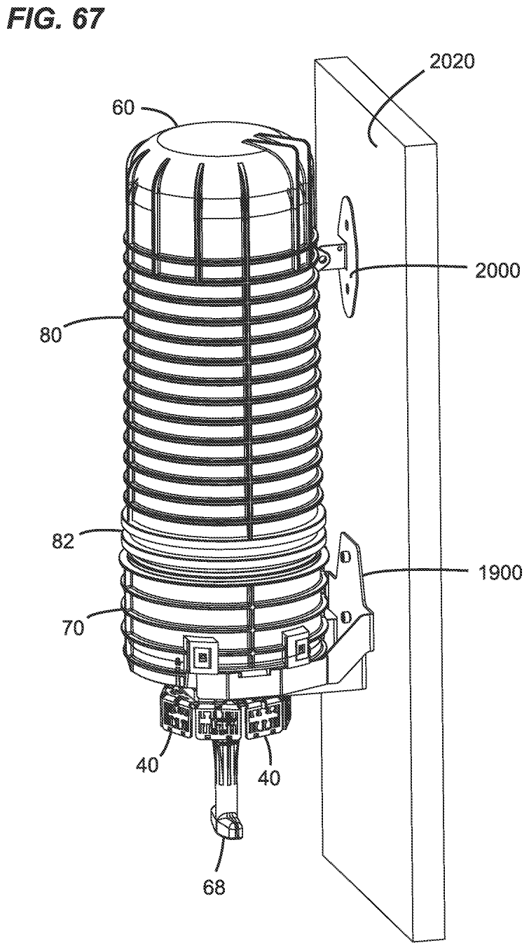

Referring now to FIGS. 60-66, another embodiment of a base interface 1010 receives a mounting bracket 1900 which is mountable to U-shaped channel 440. As in above-noted embodiments, the base interface 1010 is also mounted to interior elements 62 of a closure 60. As shown in FIGS. 61-63, base 70 of closure 60 is also mounted to mounting bracket 1900. See also FIG. 67 where base 70 of closure 60 is mounted to mounting bracket 1900 mounted to a wall 2020, instead of a U-shaped channel. The additional mounting of features on mounting bracket 1900 to closure 60 by way of base 70 helps for more secure mounting of closure 60 as the closure 60 becomes heavier, and/or longer along a central axis.

FIGS. 60-67 show inner arms 1906 of mounting bracket 1900 mounting to base interface 1010. Fasteners 1920 pass through holes 1916 of inner arms 1906 onto openings 1930 of U-shapes 1092 on base interface 1010. U-shapes 1092 include downward tabs 1932 that space inner arms 1906 from openings 1930. Holes 494 secure base interface 1010 to interior elements 62.

As shown in FIGS. 60-67, inner arms 1906 of mounting bracket 1900 are mounted to base interface 1010. This allows a technician to work on closure 60 without the presence of dome cover 80 or base 70. This may occur during manufacture, or during installation in the field. This may also occur if the closure needs to be accessed in the field after installation such as for repair, or to add new cabling in the closure.

FIGS. 60-67 also show outer arms 1910 of mounting bracket 1900 mounting to base 70, when base is present. Fasteners 1924 pass through holes 1918 of tabs 1914 of outer arms 1910 into pockets 1940 of base 70. Base 70 is axially moved in a direction toward actuator 68 to engage tabs 1914 when base 70 is to be secured to mounting bracket 1900. In this configuration, inner arms 1906 and outer arms 1910 combine to secure closure 60 to projection 440 or other structure.

Base 70 is axially moved in a direction away from actuator 68 to disengage tabs 1914 when base 70 is to be separated from mounting bracket 1900. This may occur when cables are to be added or removed from closure 60, and seal 64 must be accessed. In this configuration, inner arms 1906 are still mounted to the interior elements 62 of closure 60 through base interface 1010.

As shown in FIGS. 61-63, 65 and 66, mounting bracket 1900 includes a rear panel 1902 from which inner arms 1906 and outer arms 1910 extend. Rear panel 1902 includes openings for fastener to mount mounting bracket 1900 to another structure. One example structure is a support device 1400. Support device 1400 is mounted to U-shaped projection 440. Pin 450 mounts support device 1400 to U-shaped projection 440. Support device includes a generally square inner periphery and a generally square outer periphery.

FIG. 67 shows closure 60 mounted to a wall 2020 with the mounting bracket 1900 of FIGS. 60-63, 65, and 66. Fasteners mount rear panel to the wall. A similar arrangement can be used to mount closure 60 to a pole.

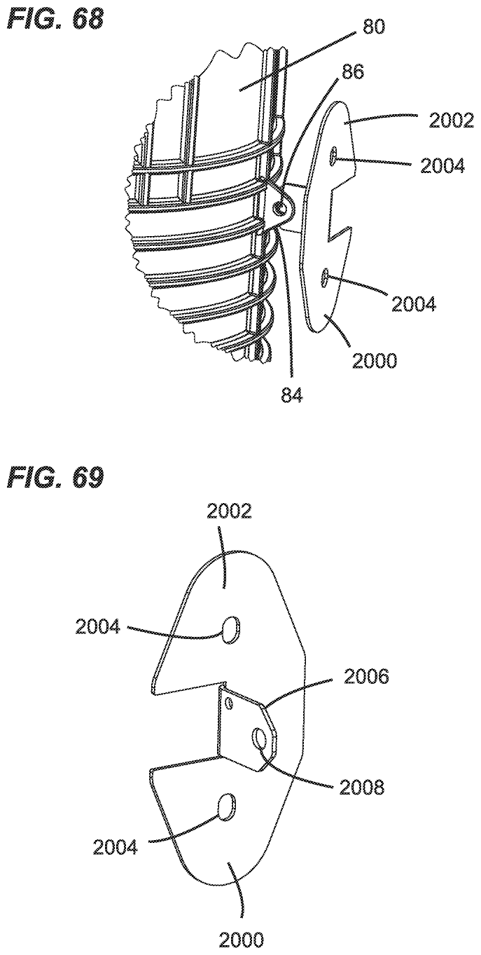

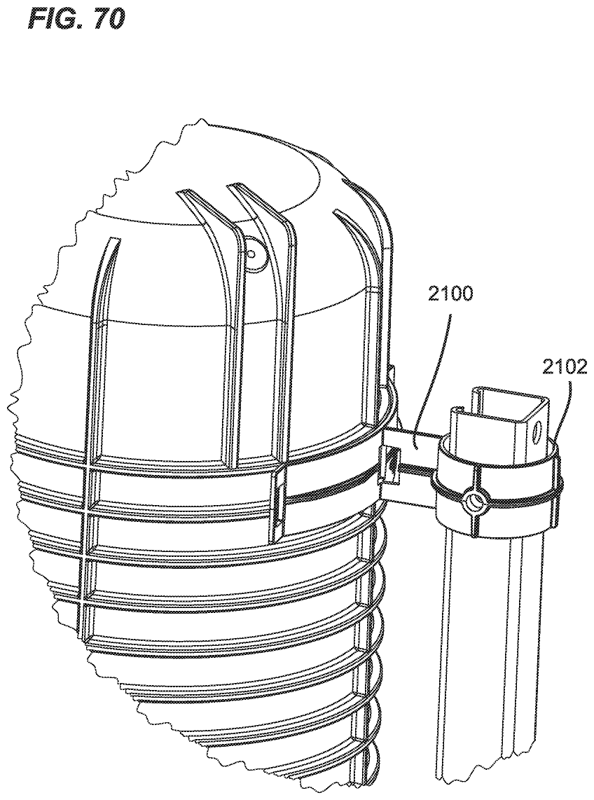

FIGS. 67-69 show a mounting support 2000 for use with the closure 60. Mounting support 2000 is spaced from mounting bracket 1900 along the longitudinal axis of closure 60. The additional mounting through mounting support 2000 helps for more secure mounting of closure 60 as the closure 60 becomes heavier, and/or longer along a central axis.

The example shown for mounting support 2000 includes a mounting panel 2002 with fastener openings 2004 to mount to the wall 2020 or other structure. A tab 2006 projects from mounting panel 2002. Opening 2008 on tab 2006 aligns with opening 86 of tab 84 of dome cover 80 for receipt of a mounting pin.

FIG. 70 shows another mounting support 2100 usable with the U-shaped projection 440. Mounting support 2100 includes a loop 2102 to be secured or positioned around the U-shaped projection. Mounting support 2100 can be connected to closure 60 with a strap.

We claim:

1. A telecommunications closure arrangement comprising:
a base interface including:
structure for mounting cable brackets to the base interface;
structure for mounting a closure interior to the base interface;
structure for mounting the base interface to a support structure.

2. The device of claim 1 wherein the base interface includes side openings.

3. The device of claims 1 and 2 wherein the base interface includes upper openings for receiving mounting rods from the interior elements of the closure.

4. The device of claims 1-3 wherein the base interface includes cable mounting brackets mounted to a lower surface or a side surface of the base interface.

5. The device of claims 1-4 wherein the base interface is mounted to a closure.

6. The device of claims 1-5 wherein the base interface is mounted to a support structure.

7. The device of claims 1-6 wherein the base interface is mounted to a support structure and a sealed closure.

8. A method of using a telecommunications closure arrangement comprising:
a base interface including:
structure for mounting cable brackets to the base interface;
structure for mounting a closure interior to the base interface;
structure for mounting the base interface to a support structure;
mounting a cable to a cable bracket;
mounting the cable bracket with the cable to the base interface;
mounting interior elements of a closure to the base interface including at least one cable bracket and at least one cable;
mounting a base of the closure to the interior elements;
mounting a dome cover of the closure to the base over the elements.

9. The method of claim 8, further comprising a step of mounting the base interface to a workstand.

10. The method of claim 9, further comprising a step of mounting the base interface to a permanent mount to a wall or a pole.

11. The method of claim 8, further comprising a step of mounting the base interface to a permanent mount to a wall or a pole.

12. The method of claims 8-11, further comprising sealing the closure while the closure is mounted to the base interface.

13. A telecommunications closure arrangement comprising:
a base interface including:
structure for mounting cables to the base interface;
structure for mounting a closure interior to the base interface;
structure for mounting the base interface to a support structure.

14. The device of claim 13 wherein the base interface receives a U-shaped rod.

15. The device of claims 13 and 14 wherein the base interface includes upper openings for receiving mounting rods or fasteners from the interior elements of the closure.

16. The device of claims 13-15 wherein the base interface includes cable mounting brackets.

17. The device of claims 13-16 wherein the base interface is mounted to a closure.

18. The device of claims 13-17 wherein the base interface is mounted to a support structure.

19. The device of claims 13-18 wherein the base interface is mounted to a support structure and a sealed closure.

20. The device of claims 13-19 wherein the support structure includes a cylindrical opening extending parallel to a main axis of the closure.

21. The device of claims 13-20 wherein the support structure can be mounted to a pole longer than the support structure.

22. The device of claims 13-21 wherein the support structure can be mounted to a planar wall.

23. The device of claims 13-22 wherein the support structure can be mounted to a U- shaped channel longer than the support structure.

24. The device of claims 13-23 wherein the support structure can be mounted to a projection of a workstand.

25. The device of claim 24 wherein the support structure can be mounted to a projection of a workstand, wherein the projection is vertically or horizontally orientated.

26. The device of claims 24 and 25 wherein the support structure can be mounted to a projection of a rotating workstand.

27. The device of claims 24-26 wherein the support structure can be mounted to rotate axially around the projection.

28. The device of claims 24-27 wherein the support structure can be mounted to slide axially relative to the projection.

29. The device of claims 24-27 wherein the projection is a U-shaped channel.

30. The device of claims 24-27 wherein the projection is a cylindrically shaped.

31. A method of using a telecommunications closure arrangement comprising:
a base interface including:
structure for mounting cables to the base interface;
structure for mounting a closure interior to the base interface;
structure for mounting the base interface to a support structure;
mounting a cable to the base interface;
mounting interior elements of a closure to the base interface;
mounting a base of the closure to the interior elements;
mounting a dome cover of the closure to the base over the elements.

32. The method of claim 31, further comprising a step of mounting the base interface to a workstand, a lift device, a wall or a pole.

33. The method of claims 31 and 32, further comprising sealing the closure while the closure is mounted to the base interface.

34. The method of claims 8-12, and 31-33, comprising mounting the base of the closure to a mounting bracket, wherein the mounting bracket is mounted to a workstand, a lift device, a wall, a pole, or other support structure, and wherein the mounting bracket is further mounted to the base interface.

35. The device of claims 1-7, and 13-30, comprising a mounting bracket configured for mounting to a base of a dome closure, wherein the mounting bracket is mountable to a workstand, a lift device, a wall, a pole, or other support structure, and wherein the mounting bracket is further mounted to the base interface.
